(19) United States
(12) Patent Application Publication
(10) Pub. No.: US 2026/0310989 A1
(43) Pub. Date: Oct. 8, 2026

(54) INTERACTIVE TEST INTERFACES

(71) Applicant: OpenAI OpCo, LLC, San Francisco, CA (US)

(72) Inventors: Jillian Khoo, Redwood City, CA (US); Karolis Kosas, Berkeley, CA (US); Scott Lessans, San Rafael, CA (US); David Weedon, Edwardsville, IL (US)

(73) Assignee: OpenAI OpCo LLC, San Francisco, CA (US)

(21) Appl. No.: 19/187,247

(22) Filed: Apr. 23, 2025

Related U.S. Application Data
(63) Continuation of application No. 19/170,539, filed on Apr. 4, 2025.

(51) Int. Cl. G06N 3/10

(52) U.S. Cl. CPC G06N 3/10

(57) ABSTRACT

The present technology pertains to an interaction control interface for testing and developing a customized generative response engine (CGRE) that includes a base generative response engine version and system instructions/message that influence outputs generated by the CGRE. The interface integrates the functions defining, modifying, and testing the CGRE to enable rapid iterations between testing and modifying the CGRE. The interface receives a configuration (e.g., a system message and a base model) of the CGRE, providing a first version of the CGRE. The interface receives a test prompt and sends the test prompt to the first version of the CGRE. The interface then receives the CGRE's response to the test prompts and presents it in the interface for evaluation by a user. Based in the response, a user can modify the CGRE's configuration to provide a second version of the CGRE, which is then tested in the same manner.

### CROSS-REFERENCE TO RELATED APPLICATIONS

This application claims priority to and the benefit of U.S. application Ser. No. 19/170,539, filed on Apr. 4, 2025, which is expressly incorporated by reference herein in its entirety.

### BACKGROUND

Developers can customize the behavior of generative response engines by creating specialized large language models (LLM s), assistants, or fine-tuned models tailored to specific applications. This customization allows for more precise control over generative response engine behavior, enabling businesses to enhance customer interactions, automate workflows, generate domain-specific content, or build AI-driven tools with unique capabilities. By adjusting parameters, integrating external APIs, and defining system instructions, developers can optimize AI responses for tasks such as customer support, content creation, research assistance, or software development. This flexibility is beneficial for organizations seeking to harness the potential of generative response engines while ensuring outputs align with their operational goals, brand voice, and ethical considerations.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some embodiments of the present technology.

FIG. 2 illustrates a flow diagram of an example of a flow diagram of an example of a routine for routine for testing configurations of a customized generative response engine using an interactive test interface in accordance with some embodiments of the present technology.

FIG. 3 illustrates an example of an interactive test interface for an assistants application programming interface (API) in accordance with some embodiments of the present technology.

FIGS. 4A-4C illustrate an example of an interactive test interface for developing and testing configurations of a customized generative response engine in accordance with some embodiments of the present technology.

FIG. 5A illustrates an example of an interactive test interface having an artificial intelligence assisted (AI-assisted) configuration creation user interface (UI) element to automate the generation of system instructions in accordance with some embodiments of the present technology.

FIG. 5B illustrates an example of an AI-assisted configuration creation UI element to automate the generation of function code in accordance with some embodiments of the present technology.

FIG. 5C illustrates an example of an AI-assisted configuration creation UI element to automate the generation of J SON schemas in accordance with some embodiments of the present technology.

FIG. 6 illustrates an example of an interactive test interface that has a functionality for requiring a customized generative response engine to make one or more tool calls in accordance with some embodiments of the present technology.

FIG. 7A-7B illustrate an example of an interactive test interface providing a function editing functionality directly in a function call in a chat history for a chat API in accordance with some embodiments of the present technology.

FIG. 8 illustrates a flow diagram of an example of a routine for side-by-side testing and comparison of configurations of customized generative response engines in accordance with some embodiments of the present technology.

FIGS. 9A-9C illustrate examples of an interactive test interface having a comparison view for a chat API in accordance with some embodiments of the present technology.

FIG. 10 illustrates a flow diagram of an example of a routine for initializing and controlling a customized generative response engine using an interactive test interface to acquire sound input and detect speech therein in accordance with some embodiments of the present technology.

FIG. 11 illustrates a flow diagram of an example of a routine for changing an appearance of one or more UI elements changes of an interactive test interface based on whether the customized generative response engine detects speech in the sound input in accordance with some embodiments of the present technology.

FIGS. 12A-12B illustrate examples of an interactive test interface for interacting with a realtime API using automatic turn detection in accordance with some embodiments of the present technology.

FIGS. 13A-13B illustrate examples of an interactive test interface for adding a function tool call to a realtime API in accordance with some embodiments of the present technology.

FIG. 14 illustrates a flow diagram of an example of a routine for using an interactive test interface to start a realtime session and control response generation by a realtime customized generative response engine in accordance with some embodiments of the present technology.

FIG. 15 illustrates a flow diagram of an example of a routine using a typing interface in an interactive test interface to enter prompts for a customized generative response engine in accordance with some embodiments of the present technology.

FIG. 16 illustrates a flow diagram of an example of a routine for using an automatic turn detection functionality of an interactive test interface in accordance with some embodiments of the present technology.

FIGS. 17A-17D illustrate examples of an interactive test interface for interacting with a realtime API without using automatic turn detection in accordance with some embodiments of the present technology.

FIG. 18 is a block diagram illustrating an example machine-learning platform for implementing various aspects of this disclosure in accordance with some aspects of the present technology.

FIGS. 19A-19C illustrate an example of a transformer architecture in accordance with some embodiments of the present technology.

FIG. 20 shows an example of a system for implementing some embodiments of the present technology.

### DETAILED DESCRIPTION

Generative response engines, such as large language generative response engines, represent a significant milestone in artificial intelligence, revolutionizing computer-based natural language understanding and generation. These engines, powered by advanced deep learning techniques, have demonstrated remarkable capabilities in tasks such as text generation, translation, summarization, and even code generation. Their adaptability has unlocked new possibilities across industries, enabling automation, enhanced communication, and intelligent assistance in various applications.

Developers can tailor generative response engines by creating specialized GPTs, assistants, or fine-tuned generative response engines suited to specific applications. This customization allows for precise control over the engine's behavior, empowering businesses to refine customer interactions, automate workflows, generate domain-specific content, or develop AI-driven tools with unique functionalities. By adjusting parameters, integrating external A Pls, and defining system instructions, developers can optimize AI responses for tasks such as customer support, content creation, research assistance, or software development. This flexibility is crucial in ensuring that generative response engines align with operational goals, brand voice, and ethical considerations.

Before the introduction of the interactive test interface in the present technology, developers faced significant obstacles in testing and refining their customizations. Making iterative changes to the generative response engine required multiple steps, including modifying configurations, deploying updates, and running extensive manual tests to evaluate the impact of adjustments. This process was not only time-consuming but also hindered rapid improvements in AI performance.

One primary difficulty was the lack of real-time feedback on how different configurations influenced generative response engine behavior. Developers had to rely on a trial-and-error approach, making adjustments and manually analyzing the outputs without clear indicators of what changes were most effective. This inefficiency became even more pronounced when fine-tuning generative response engines for complex applications like conversational AI, content generation, or speech-based interactions.

Another significant challenge was the inability to control interaction flow with granular precision. M any generative response engines operate within a rigid request-response framework, where every input automatically triggers a generative response engine response. This structure made it difficult for developers to isolate and debug specific components of the interaction, such as understanding how the generative response engine processed a given input before generating an output.

The interactive test interface effectively addresses these challenges by providing a dynamic environment where developers can seamlessly modify configurations, test changes in real time, and quickly observe generative response engine outputs. This streamlined workflow enhances prompt engineering, response tuning, and feature testing, ultimately accelerating the development cycle. By offering an intuitive and responsive testing platform, the interactive test interface enables developers to fine-tune generative response engines with greater efficiency, ensuring that AI-driven applications deliver accurate, relevant, and contextually appropriate outputs.

Testing a generative response engine with real-time capabilities and support for multiple input and output modalities—such as text, speech, and image processing—presents even greater challenges. For instance, in speech-based applications, a lack of visibility into when the system detects audio input or when speech is actively processed can create uncertainty, complicating debugging efforts.

Moreover, generative response engine behavior is often tied to a continuous, uninterrupted inference process. Developers have limited control over whether a generative response engine should generate an output or skip a response altogether. This can lead to unnecessary delays and wasted resources when a lengthy response is unnecessary, especially when a short answer is sufficient to confirm that the generative response engine functions as intended.

One notable improvement is the ability to toggle turn detection on or off. This feature allows developers to control when the generative response engine should respond during testing, which is particularly beneficial in collaborative environments. In such scenarios, the generative response engine may struggle to differentiate between human conversations and verbal prompts directed at the AI. Having the option to disable turn detection prevents unintended interruptions and ensures smoother testing.

For speech-based applications, the interactive test interface now provides real-time feedback on audio processing. Developers can see precisely when audio is sent to the generative response engine and when speech is detected, eliminating guesswork and enabling more precise tuning of voice-based interactions. By understanding when the system recognizes speech input and how it processes it, developers can troubleshoot latency issues, refine activation thresholds, and improve response accuracy.

These enhancements contribute to a more efficient development workflow by reducing iteration time—often cutting testing cycles from hours to minutes—and providing clearer insights into generative response engine behavior. By enabling real-time modifications and immediate observation of outputs, developers can rapidly identify and implement necessary refinements, significantly improving productivity and overall generative response engine accuracy. Instead of manually testing numerous configurations and waiting for responses, developers can now make adjustments instantly, observe immediate effects, and fine-tune their generative response engines with greater precision.

The interactive test interface represents a crucial advancement in AI generative response engine development, offering developers a streamlined, responsive, and intuitive testing environment. By addressing key challenges in generative response engine testing, particularly in real-time and multi-modal applications, this technology empowers developers to create more robust, efficient, and user-friendly AI systems. As generative AI continues to evolve, the ability to test, refine, and optimize responses efficiently will remain a cornerstone of its successful implementation across industries.

In some aspects, the techniques described herein relate to a method of testing a first configuration of a customized generative response engine, the method including: receiving a first configuration of the customized generative response engine by an interactive test interface, wherein the first configuration includes a system message and a first base generative response engine version, receiving a test prompt in the interactive test interface; sending the test prompt and to the customized generative response engine; receiving a response from the customized generative response engine; and presenting the response from the customized generative response engine in the interactive test interface for evaluation by a user, wherein: the system message is a directive provided to the first base generative response engine version which customizes the first base generative response engine version into the customized generative response engine to influence outputs generated by the customized generative response engine, the system message often includes operational parameters, behavioral constraints, or contextual guidance, the first base generative response engine version is a generative response engine that is provided by an artificial intelligence model publisher, wherein the first base generative response engine version is a generative pre-trained transformer, a language model, a multi-modal model, a diffusion model, a diffusion-transformer model, an embedding model, or any combination thereof, and the customized generative response engine is the first base generative response engine version that is customized by the first configuration.

In some aspects, the techniques described herein relate to a method of interacting with real-time generative response engines having one or more user interface (UI) elements, the method including: presenting an interaction control interface for use with a real-time generative response engine, wherein the interaction control interface is configured to: receive a first input that is effective to start a real-time communication session, receive a second input that is effective to stop or pause the real-time communication session, and receive a third input that is effective to cause the real-time generative response engine to stop generating a particular response.

In some aspects, the techniques described herein relate to a method of interacting with real-time generative response engines having automatic turn detection capabilities, the method including: presenting an interaction control interface for use with a real-time generative response engine when automatic turn detection is enabled, wherein the interaction control interface is configured to receive inputs that are effective to start a real-time communication session, to stop or pause the real-time communication session, cause the real-time generative response engine to stop generating a particular response.

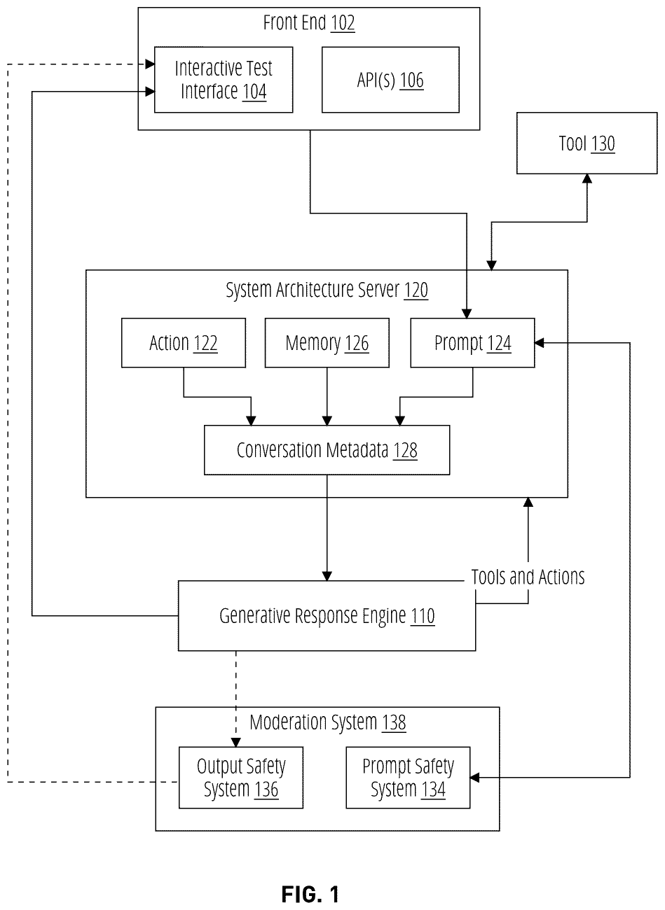

FIG. 1 illustrates an example system supporting a generative response engine during inference operations in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., a generative pre-trained transformer) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 110 through the front end 102. The front end 102 serves as the interface and intermediary between the user and the generative response engine. It encompasses the interactive test interface 104 and Application Programming Interfaces (A Pls) 106 that facilitate communication, input processing, and output presentation. Generally, users interact through an interactive test interface 104 that often includes a conversational interface to test their customized generative response engine, but once tested might use applications to interact through the API 106 to interact with the customized generative response engine, but this is not a requirement.

The interactive test interface 104 is the platform through which users interact with the generative response engine 110. It can be a web-based chat window, a mobile application, or any interface that supports data input and output. The interactive test interface 104 facilitates a conversation between the user and the generative response engine, as the user provides prompts in the interactive test interface 104 to which the generative response engine responds and presents those responses in the interactive test interface 104. In some embodiments, interactive test interface 104 presents a conversational interface, which has attributes of a conversation thread between a user account and generative response engine 110.

The interactive test interface 104 is configured to perform input handling, context management, and output presentation. The type of inputs that can be received can be relative to the specifics of the generative response engine 110. But even when a model doesn't directly accept certain types of inputs, the front end 102 might be able to receive different types of inputs, which can be converted to inputs that are accepted by the generative response engine 110. For example, a single modality language model is generally configured to accept text, but the front end 102 can accept voice and convert it to text or accept an image and create a textual representation. Of course, there are also multi-modal generative response engines that can receive vision, voice, and text. The generative response engine can be a single modality generative response engine or a multi-modal generative response engine.

The interactive test interface 104 is also configured to maintain the context of the conversation, which allows for coherent and relevant responses. For example, interactive test interface 104 is responsible for providing the conversation thread and other relevant context accessible to the front end 102 to the generative response engine along with the specific prompt to the generative response engine. In an example, a conversation between the user account and the generative response engine 110 can have taken several turns (prompt, response, prompt, response, etc.). When the user account provides a further prompt, the interactive test interface 104 can provide that prompt to the generative response engine in the context of the entire conversation.

In another example, the front end 102 might have access to a memory 126 where facts about the user account have been stored. In some embodiments, these facts can have been identified as facts worth storing by the generative response engine and the front end 102 has stored these facts at the direction of the generative response engine. Accordingly, these facts can be provided to the generative response engine 110 along with a user-provided prompt so that the generative response engine has access to these facts when generating a response.

In another example, the interactive test interface 104 might be configured to provide a system prompt along with a user-provided prompt. A system prompt is hidden from the user account during live use, but might be shown during testing and may be edited. The system prompt is used to set the behavior and guidelines for the generative response engine. It can be used to define the AI's persona, style, and constraints.

The interactive test interface 104 is also configured to display the responses from the generative response engine, which might include text, code snippets, images, or interactive elements.

In some embodiments, the generative response engine 110 can provide instructions to the front end 102 that instruct the interactive test interface 104 about how to display some of the output from the generative response engine. For example, the generative response engine can direct the interactive test interface 104 to present code in a code-specific format, or to present interactive graphics, or static images. In other examples, the generative response engine can direct the interactive test interface 104 to present an interactive document editor where the interactive test interface 104 can be presented with the document editor so that the user account and the generative response engine can collaborate on the document. In some embodiments, the generative response engine 110 can provide instructions to the front end 102 to record facts in a personalization notepad. Accordingly, the interactive test interface 104 does not always display all of the output of the generative response engine.

As noted above, the front end 102 can also provide one or more application programming interfaces (API(s)) 106. APIs enable developers to integrate the generative response engine's capabilities into external applications and services. They provide programmatic access to the generative response engine, allowing for customized interactions and functionalities. In some embodiments, the interactive test interface 104 can be an interface to test the configuration of a customized generative response engine for use when called through a specific API 106, and aid in configuration of the customized generative response engine to be called through API 106.

The A Pls 106 can accept structured requests containing prompts, context, and configuration parameters. For example, an API can be used to provide prompts and divide the prompt into system prompts and user prompts. In some embodiments, the A Pls 106 can provide specific inputs for which the generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common A Pls are for participating in a conversation (Chat Completion API), for providing a single response (Completion API), for converting text into embeddings (Embeddings API), etc. The API can also be used to indicate specific decision boundaries that the generative response engine 110 might be trained to interpret. For example, the moderation API can take advantage of the generative response engine's content moderation decision-making. In the case of the moderation API and others, the API might give access to services other than the generative response engine. For example, the moderation API might be an interface to moderation system 138, addressed below.

Some other common A Pls include the Fine-Tuning API, which allows developers to customize models of the generative response engine using their own datasets; the Audio and Speech A Pls, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the interactive test interface 104 and the A Pls 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a system architecture server 120. The function of system architecture server 120 is to manage and organize the flow of data among key subsystems, enabling the generative response engine 110 to generate responses that are contextually relevant, accurate, and enriched with additional information as required.

Action 122 facilitates auxiliary tasks that extend beyond basic text generation. In some embodiments, action 122 can be actions that correspond to an API 106. In some embodiments, action 122 can be agentic actions that the generative response engine 110 decides to take to carry out a user's intent as described in the prompt.

Prompt 124 is the request or command provided by the user account through front end 102. In some embodiments, prompt 124 can be further supplemented by a system prompt and other information that might be included by interactive test interface 104 or API 106. In some embodiments, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. Generally, prompt 124 will include an entire conversation thread, but in some instances, prompt 124 might need to be shortened if it exceeds a maximum accepted length (generally measured by a number of tokens).

System architecture server 120 can also route prompts and response through moderation system 138, which can be separate or part of system architecture server 120. In some embodiments, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some embodiments, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some embodiments, memory can be recorded at the instruction of generative response engine 110 when generative response engine 110 identifies a fact or data that it determines should be saved in memory because it might be useful in later conversations or sessions.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from system architecture server 120) and generates outputs. In some embodiments, the generative response engine is a Generative Pre-trained Transformer (GPT), but it could utilize other architectures.

A core feature of the generative response engine 110 is to generate content in response to prompts. When the generative response engine 110 is a GPT, it is configured to receive inputs from front end 102 that provide guidance on a desired output. The generative response engine can analyze the input and identify relevant patterns and associations in the data, and it has learned to generate a sequence of tokens that are predicted as the most likely continuation of the input. The generative response engine 110 generates responses by sampling from the probability distribution of possible tokens, guided by the patterns observed during its training. In some embodiments, the generative response engine 110 can generate multiple possible responses before presenting the final one. The generative response engine 110 can generate multiple responses based on the input, and these responses are variations that the generative response engine 110 considers potentially relevant and coherent.

In some embodiments, the generative response engine 110 can evaluate generated responses based on certain criteria. These criteria can include relevance to the prompt, coherence, fluency, and sometimes adherence to specific guidelines or rules, depending on the application. Based on this evaluation, the generative response engine 110 can select the most appropriate response. This selection is typically the one that scores highest on the set criteria, balancing factors like relevance, informativeness, coherence, and content moderation instructions/training.

In some embodiments, an instruction provided by an API 106, a system prompt, or a decision made by generative response engine 110 can cause the generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

The generative response engine 110 can also do more than generate content in response to a prompt. In some embodiments, the generative response engine 110 can utilize decision boundaries to determine the appropriate course of action based on the prompt. In some examples, a decision boundary might be used to cause the generative response engine to recognize that it is being asked to provide a response in a particular format, such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ), and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, the generative response engine 110 might call a tool 130 or cause an action 122 to be performed. As indicated above, tools 130 can include internet browsers, editors such as code editors, other AI tools etc. Actions 122 are actions that the generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that the generative response engine 110 can control the computer operating system on the user's behalf, to robotic actuators, to search browsers and specific applications.

Additionally, the generative response engine 110 can also generate portions of responses that are not displayed to the user. For example, generative response engine 110 can direct the front end 102 to provide specific behaviors, such as directions for how to present the response from the generative response engine 110 to the user account. In another example, the generative response engine 110 can provide response portions dictated by an API, where portions of the response to the API might be for the consumption of the calling application but not for presentation to the end user.

In some embodiments, the output of generative response engine can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some embodiments, the responses might be returned by way of system architecture server 120.

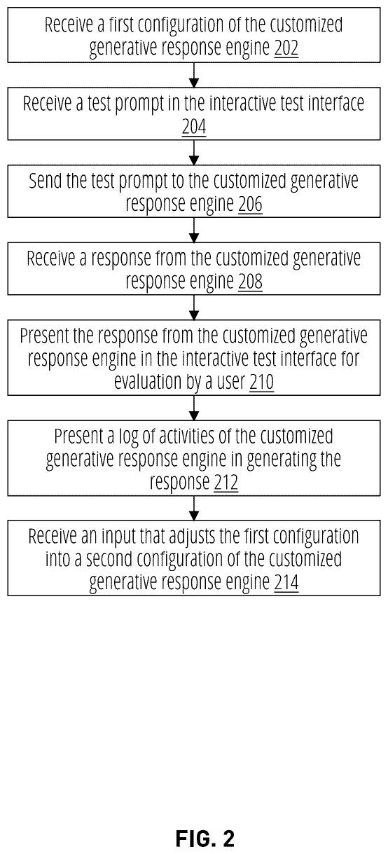

FIG. 2 illustrates an example routine for testing a first configuration of a customized generative response engine in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

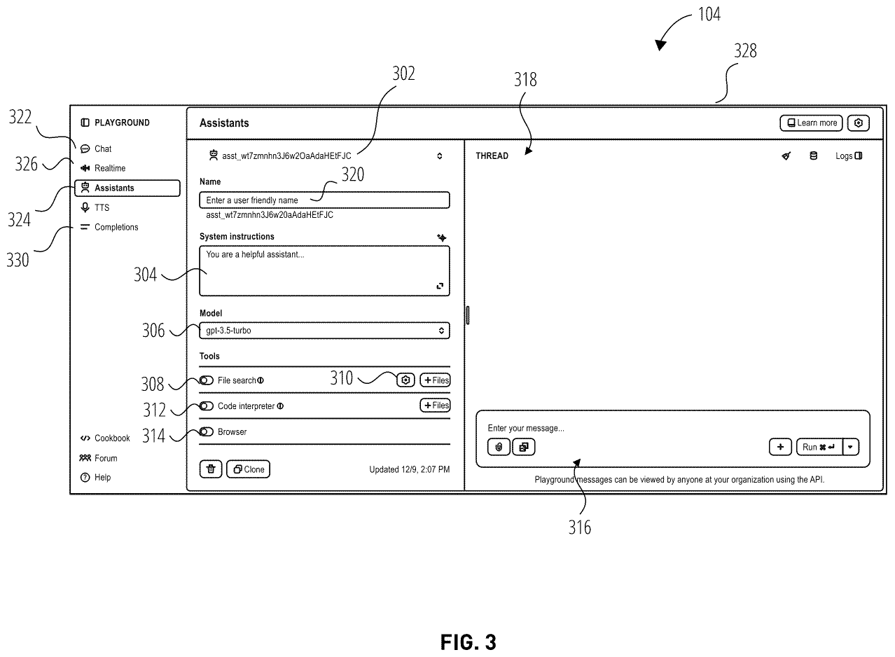

According to some examples, the method includes receiving a first configuration of the customized generative response engine at block 202. For example, interactive test interface 104 illustrated in FIG. 3 may receive a first configuration of the customized generative response engine. For example, the first configuration system can include instructions entered in system message 304, a base generative response engine version that is selected via base generative response engine version 306 and tools that are defined using file search tool toggle 308, file search tool configuration 310, code interpreter tool toggle 312, and browser tool toggle 314.

The first configuration includes at least a system message and a base generative response engine version, but other configurations can also be included in the first configuration. The customized generative response engine is the base generative response engine version that is customized by the first configuration.

The system message is a directive provided to the base generative response engine version the base generative response engine version to influence outputs. The system message often includes operational parameters, behavioral constraints, or contextual guidance.

The base generative response engine version is a generative response engine that is provided by an artificial intelligence model publisher. For example, the base generative response engine version could be GPT-40, GPT-03, SORA, from OPENAI or CLAUDE SONNET from ANTHROPIC, etc. In some embodiments, the base generative response engine version is a generative pre-trained transformer, a language model, a multi-modal model, a diffusion model, a diffusion-transformer model, an embedding model, or any combination thereof.

Additional configurations that can be part of the first configuration can include enabling the base generative response engine version to access tools, such as code interpreter tools (e.g., functions can be added by enabling code interpreter tool toggle 312), file search tools (e.g., by enabling file search tool toggle 308), internet browsing tools (e.g., by enabling browser tool toggle 314), function calling tools, and even the ability to interact with other AI tools or agents.

The are several ways that interactive test interface 104 can receive the first configuration of the customized generative response engine. In one example, the first configuration can be imported from a library of previously configured customized generative response engines. In another example, a developer can use interactive test interface 104 to enter the first configuration or to modify an existing configuration.

An example of an interactive test interface is illustrated as interactive test interface 104 in FIG. 3. Interactive test interface 104 includes system message 304, base generative response engine version 306, file search tool toggle 308, file search tool configuration 310, code interpreter tool toggle 312, browser tool toggle 314, among other fields and controls that can be used to create or modify a first configuration of customized generative response engine.

The interactive test interface is configured to test the customized generative response engine for use with a plurality of application programming interface (API) endpoints. Examples of the API endpoints include a chat completions API endpoint 322, a responses API endpoint, an assistants API endpoint 324, a realtime API endpoint 326, a computer using agent API endpoint, etc.

The chat completions API endpoint is an interface that enables structured conversational interactions with the customized generative response engine by processing developer messages, maintaining contextual awareness, and generating coherent responses based on dialogue history. The assistants API is an interface to interact with the customized generative response engine that is configured to act like an assistant that specializes in a type or category of tasks and has a long context history to allow it to recall past turns. The realtime API is an interface that facilitates real-time communication with the customized generative response engine, enabling natural conversational speech interactions. The computer using agent API is an interface to interact with the customized generative response engine that is configured to control a computer by processing images of a graphical user interface. The responses API is an interface that combines attributes of other APIs into a single interface.

According to some examples, the method includes receiving a test prompt in the interactive test interface at block 204. For example, interactive test interface 104 illustrated in FIG. 3 may receive a test prompt in the interactive test interface. The test prompt can be input into prompt editor 316 illustrated in FIG. 3.

According to some examples, the method includes sending the test prompt to the customized generative response engine at block 206. For example, interactive test interface 104 illustrated in FIG. 3 may send the test prompt to the customized generative response engine. The customized generative response engine can be loaded into the memory of a computing unit such as a graphics processing unit (GPU) or collection of computing units, and the customized generative response engine, which is configured according to the first configuration, is configured to receive the prompt and output a response.

According to some examples, the method includes receiving a response from the customized generative response engine at block 208. For example, interactive test interface 104 illustrated in FIG. 3 may receive a response from the customized generative response engine.

According to some examples, the method includes presenting the response from the customized generative response engine in the interactive test interface for evaluation by a developer at block 210. For example, interactive test interface 104 illustrated in FIG. 3 may present the response from the customized generative response engine in conversational interface 318 together with the prompt.

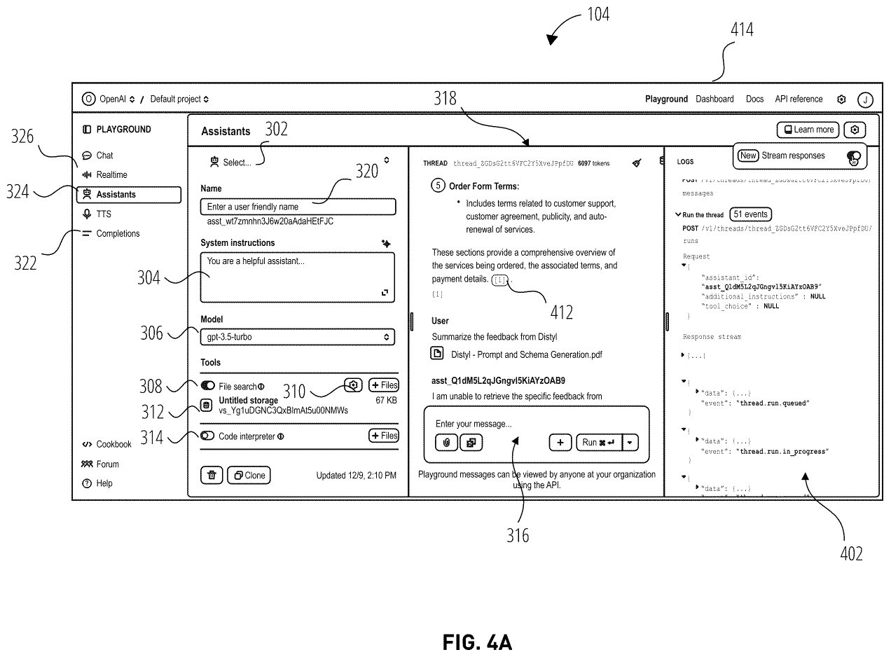

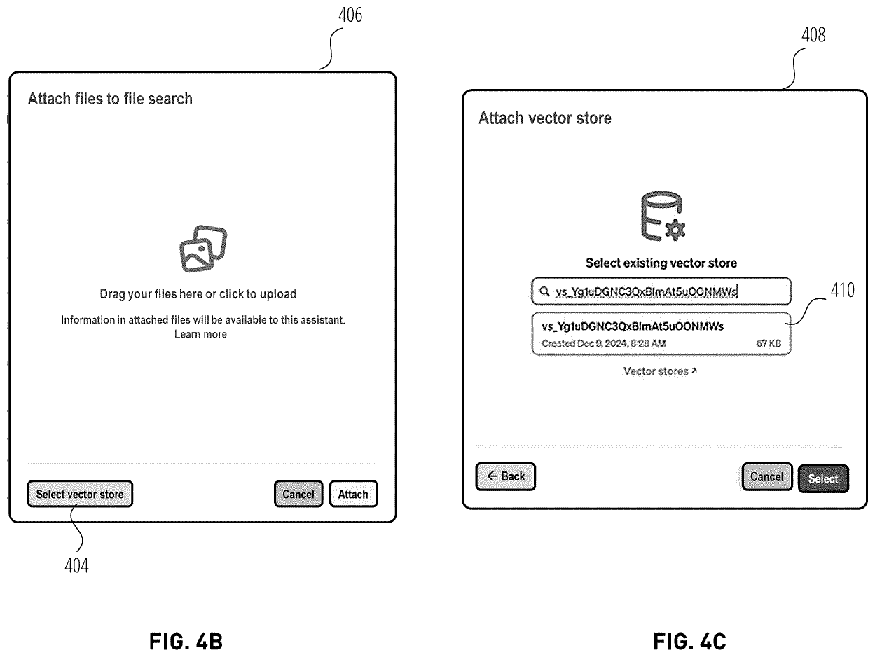

According to some examples, the method includes presenting a log of activities of the customized generative response engine in generating the response at block 212. For example, log 402 of interactive test interface 104 illustrated in FIG. 4A may present a log of activities of the customized generative response engine in generating the response. To aid a developer in understanding how the customized generative response engine might be working (or not working as desired), interactive test interface 104 can present log 402, which includes a log of activities and hidden outputs from the customized generative response engine. Activities can include information about a chain of thought, files accessed, internet search results accessed and found relevant, portions of documents and webpages found relevant and used to create the response, tools called, etc.

When the developer determines that the customized generative response engine can be improved, or the developer wants to test a different configuration, the developer can change the configurations by interacting with interactive test interface 104.

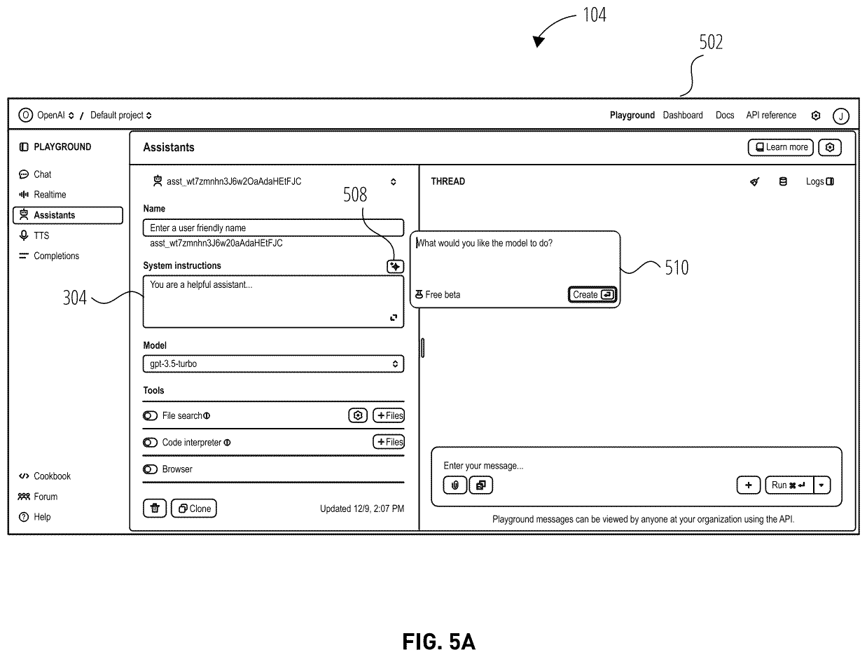

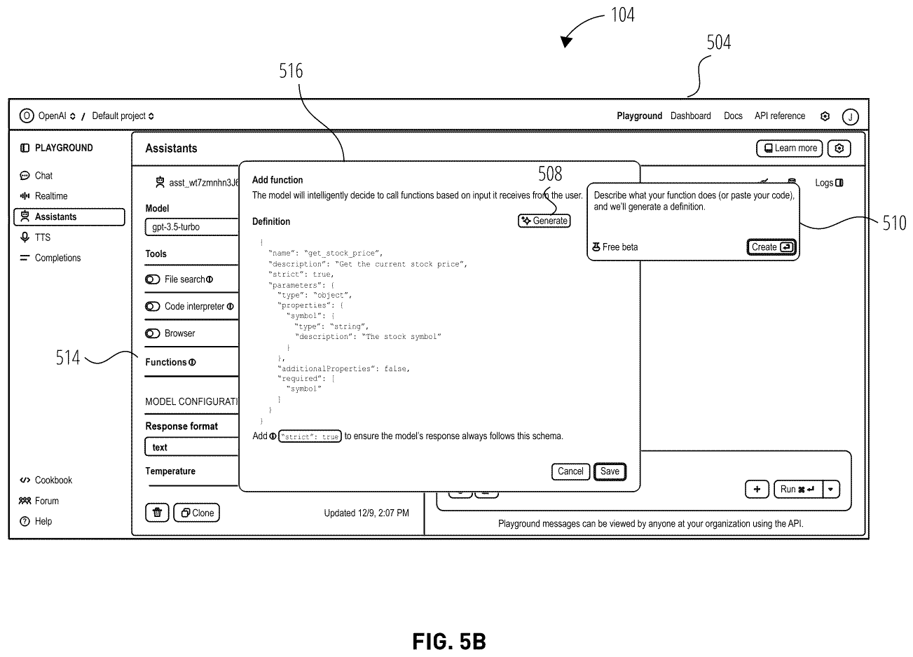

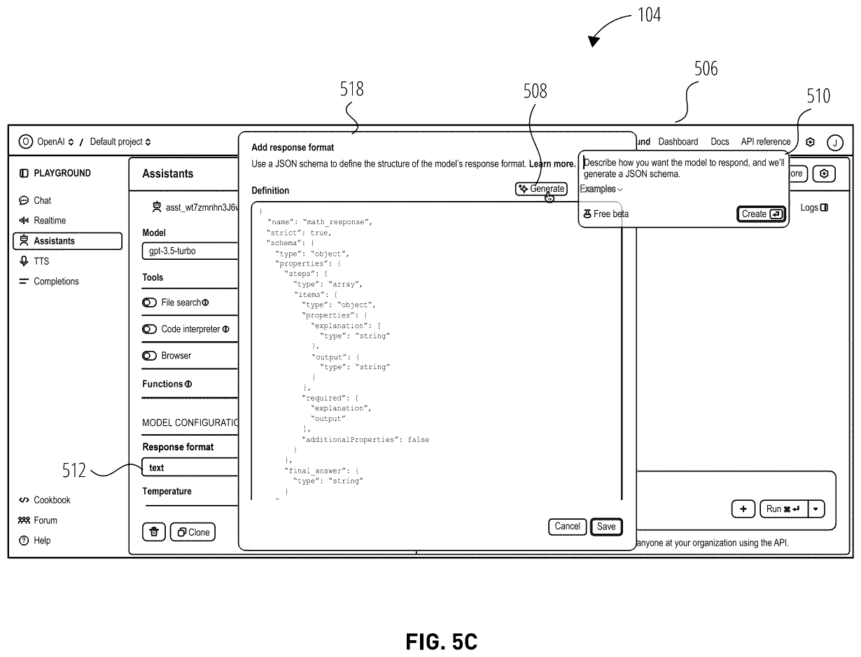

According to some examples, the method includes receiving an input that adjusts the first configuration into a second configuration of the customized generative response engine at block 214. For example, a user can use the various input options in interactive test interface 104 illustrated in FIG. 3 to modify a configuration input and thereby adjust the first configuration into a second configuration of the customized generative response engine. Thereafter, the customized generative response engine with the second configuration can be tested with the test prompt or a second test prompt. The receiving the input that adjusts the first configuration into a second configuration can include receiving a selection of an AI-assisted configuration creation button (e.g., generate element 508 illustrated in FIG. 5A, FIG. 5B, and FIG. 5C).

As these terms are used herein, the first configuration and second configuration are different configurations of the customized generative response engine.

FIG. 3 shows a first view 328 of interactive test interface 104 that allows developers to develop and test AI applications by selecting among playground environments for various A Pls, including but not limited to, chat API 322, assistants API 324, realtime API 326, and completions API 330. In first view 328, the assistants API playground option (e.g., assistants API 324) is selected to bring up the assistants API playground window view, which is an interactive development interface that enables developers to develop and test assistants APIs to quickly prototype and obtain feedback on their assistants.

For example, the playground for assistants (i.e., the Assistants API) enables the developer to build AI assistants within their own applications. An Assistant has instructions and can leverage models, tools, and files to respond to queries of a user. The Assistants API can support various types of tools, which are illustrated using the non-limiting examples of a Code Interpreter tool, File Search tool, and a Browser tool, which are selected using code interpreter tool toggle 312, file search tool toggle 308, and browser tool toggle 314. Further, the assistants API enables developers to define and use function calls.

The assistants API provides various fields and options to customize and test responses of the assistants API to user interactions with AI models. Some of these fields and selection options include, but are not limited to, a name/identifier (ID) for the customized generative response engine (e.g., customized generative response engine 302), instructions to the system direction that assistants AI behavior (e.g., system message 304, base generative response engine version 306, file search tool toggle 308, file search tool configuration 310, code interpreter tool toggle 312, browser tool toggle 314, prompt editor 316, conversational interface 318, and customized generative response engine name 320.

The name field (e.g., customized generative response engine name 320) allows developers to assign a custom name to their session or preset. Further, customized generative response engine name 320 can help to organize different configurations for repeated use and to provide a useful reference.

The system instructions field (e.g., system message 304) can be a text box where developers can specify directives to guide the AI's behavior. For example, instructions can define tone, style, persona, and constraints for the customized generative response engine. An example of an entry for system message 304 can be “You are a formal and concise assistant. Answer only with factual information.”

The model field (e.g., base generative response engine version 306) can be used to select a base generative response engine version. The available base generative response engine versions (e.g., GPT-4-turbo versus GPT-3.5) can vary in capability. The choice of base generative response engine version can affect response quality, speed, and cost.

The tools selection options enable developers to select additional functionalities that extend the capabilities of the customized generative response engine. A vailable options can include, but are not limited to, file search tool toggle 308, code interpreter tool toggle 312, and browser tool toggle 314. File search allows the customized generative response engine to reference uploaded files for answering queries. The code interpreter can enable the execution Python code for calculations, data analysis, and more. The browser functionalities can provide access to the web for retrieving real-time information.

The message field (e.g., prompt editor 316) provides an input area where developers type their prompts and interact with the customized generative response engine. For example, developers can enter queries, instructions, or engage in a back-and-forth conversation. Prompt editor 316 can support multi-turn interactions where the model remembers context within the session. Conversational interface 318 is where the customized generative response engine provides a thread of the back-and-forth conversation, as illustrated in FIG. 4A. By entering prompts 124 in prompt editor 316 and observing the conversation thread in conversational interface 318, a developer obtains rapid feedback and insight into whether the customized generative response engine is responding as desired. Based on this feedback and insight, the developer can then make changes to their customized generative response engine to further customize the developer's customized generative response engine.

FIG. 4A shows a second view 414 of interactive test interface 104 in which assistants API 324 is selected. In FIG. 4A, a non-limiting example of a customized generative response engine is illustrated in which the customized generative response engine is configured to respond to queries based on the contents of attached files. In this example, an order form is attached, and the customized generative response engine responds to a query “What is in the order form.” As shown in FIG. 4A, the customized generative response engine has file search tool toggle 308 toggled to enable searching files, and a file has been uploaded.

For example, selecting file search tool configuration 310 can cause attach file element 406 to be displayed, which is shown in FIG. 4B, and selecting select vector element 404 in attach file element 406 can cause attach vector store element 408 to be displayed, which is shown in FIG. 4C. In attach vector store element 408, vector store entry element 410 can be used to select/enter a vector store that is used for the file search functionality.

Once the file has been attached, queries can be entered related to the attached files. In FIG. 4A, a query of “What is in the order form,” to which the customized generative response engine provides a summary of order form terms and a summary of the file together with source references 412 to the attached files.

FIG. 4A also shows log 402, which is the recorded history of interactions within a session, providing a detailed breakdown of the conversation. The recorded history tracks developer inputs and the AI responses. For example, log 402 can capture every message sent by the developer and the AI's corresponding reply. Developers can review the log to understand how the AI responded, identify errors, and improve prompts. When tools like the code interpreter or file search are used, log 402 can include: (1) code execution details; (2) files accessed; and (3) function calls made by the assistant. Log 402 can be used to track how the assistant processes requests over multiple interactions. Log 402 can be used to replicate or adapt assistant behavior by reviewing previous conversations. Elements within log 402 can be expanded or collapsed. Further 402 and include references to the attached files. When the query includes searching a provided document, log 402 can provide a ranking of search results and information about how the customized generative response engine decided the results.

FIGS. 5A-5C show various examples of using an AI-assisted configuration creation button (e.g., generate element 508) to provide a generate functionality to automate time-consuming tasks that can be performed using AI such as writing Python code for functions or JSON schemas for response outputs. Generate element 508 is provided in numerous locations and contexts within interactive test interface 104 to use AI to aid in time-consuming tasks that can be largely automated using AI.

For example, in response to selecting generate element 508, text entry element 510 is displayed, allowing the developer to provide a plain language description of the desired functionality. An AI tool then generates a recommendation (e.g., recommended instructions, Python code, JSON schema, etc.) to achieve the desired functionality. Even when the recommendation generated by the AI tool does not exactly match the developer's desired functionality (e.g., due to a short coming of the AI tool or due to the developer's plain language description of the desired functionality being incomplete), the provided recommendation can nevertheless provide a reasonable approximation to the developer's desired functionality. Thus, by editing the recommendation, the developer can expedite the generation of system instructions, Python code, and JSON schema, compared to writing them from scratch.

According to certain non-limiting examples, generate element 508 is an AI-assisted configuration creation button that is presented in multiple locations within the interactive test interface. Selecting the AI-assisted configuration creation button opens a text input element in which the developer can provide the plain language description of the desired functionality, which is provided as a prompt to the AI tool that generates a portion of the second configuration, such as system message 304, Python code to be run by a code interpreter tool, or a J SON schema for a response format. The generated code or other content from the AI tool associated with generate element 508 can be an input that adjusts the first configuration into the second configuration of the customized generative response engine. Further, the plain language description of the desired functionality, which is provided in text entry element 510, is an input to enable the customized generative response engine to make use of the generate functionality (e.g., the AI tool).

FIG. 5A shows a third view 502 of interactive test interface 104 in which assistants API 324 is selected. In FIG. 5A, Generate element 508 is used to generate system instructions in system message 304. For example, selecting generate element 508 in FIG. 5A causes text entry element 510 to be displayed. According to certain non-limiting examples, entering the text “write an abstract for a technical paper” in text entry element 510 of FIG. 5A results in system message 304 being populated with the following text:

Write an abstract for a technical paper based on its content.

Analyze the provided body of the paper to identify key elements, including the research objective, methods, results, and conclusions. Then, summarize these elements in an abstract format that accurately represents the content and findings of the paper.

### #Steps

1. **Objective Identification**: Determine the main research goal or problem addressed in the paper. 2. **Methodology Summary**: Briefly describe the methods and approaches used in the research. 3. **Results Overview**: Summarize the main findings or results of the research. 4. **Conclusions**: Outline the implications, impacts, or conclusions drawn from the results.

### #Output Format

The abstract should be a single paragraph, typically not exceeding 250 words, clearly structured to include the objective, methods, results, and conclusions in that order.

### EXAMPLES

### Example Start

**Input (Body of the Paper):**—The paper discusses the development and testing of a new algorithm for data compression. The objective is to improve compression speeds without a significant loss of accuracy. Various tests were conducted comparing the algorithm to existing methods in terms of speed and accuracy. Results show that the new algorithm achieves a 20% increase in speed with only a 1% decrease in accuracy.

**Output (Abstract):**—This study focuses on the development of an innovative data compression algorithm aimed at enhancing computational speed while maintaining accuracy. Employing rigorous comparative testing methodologies, the research demonstrates that the proposed algorithm delivers a notable 20% performance improvement over existing alternatives, with a minimal accuracy trade-off of 1%. The findings suggest valuable applications in fields requiring efficient data processing solutions.

### Example End

### #Notes

Ensure clarity and lack of jargon in the abstract unless industry-standard terms are necessary. —Maintain objectivity and neutrality in presentation. —Prioritize the most significant results and implications.

FIG. 5B shows a fourth view 504 of interactive test interface 104 in which assistants API 324 is selected. In FIG. 5B, generate element 508 is used to generate a function. For example, selecting add function element 514 in FIG. 5A causes code entry element 516 to be displayed. Then, selecting generate element 508 in code entry element 516 causes text entry element 510 to be displayed. According to certain non-limiting examples, entering the text “calculate 50 day average price for a selected stock” in text entry element 510 of FIG. 5B results in code entry element 516 being populated with the following code:

```
  {
    “name”: “calculate_50_day_average_price”,
    “description”: “Calculate 50 day average price for a selected stock”,
    “strict”: true,
    “parameters”: {
      “type”: “object”,
      “required”: [
        “ticker”,
        “start_date”,
        “end_date”
      ],
      “properties”: {
        “ticker”: {
            “type”: “string”,
            “description”: “The stock ticker symbol for which to calculate the 50 day
average price.”
          },
        “start_date”: {
          “type”: “string”,
          “description”: “The start date from which to calculate the average price,
formatted as YYYY-MM-DD.”
        },
        “end_date”: {
            “type”: “string”,
            “description”: “The end date up to which to calculate the average price,
formatted as YYYY-MM-DD.”
          }
        },
      “additionalProperties”: false
      }
    }
```

FIG. 5C shows a fifth view 506 of interactive test interface 104 in which assistants API 324 is selected. In FIG. 5C, generate element 508 is used to generate a J SON schema for a response. For example, selecting response format element 512 in FIG. 5C and selecting JSON schema causes schema entry element 518 to be displayed. Then, selecting generate element 508 in schema entry element 518 causes text entry element 510 to be displayed. Entering the text in text entry element 510 in FIG. 5C results in the generation of an example J SON schema that can be used by the customized generative response engine to format responses.

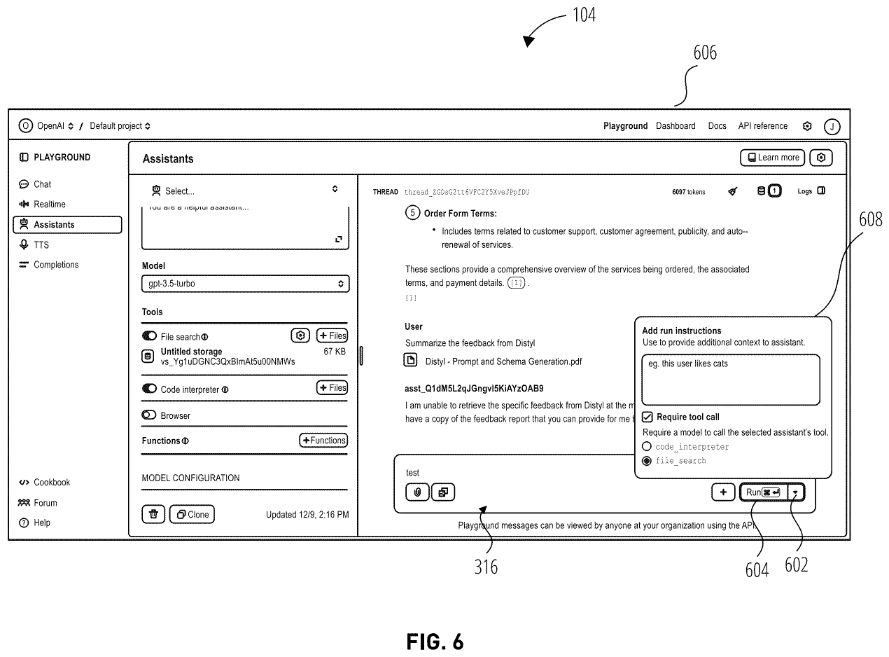

FIG. 6 illustrates a sixth view 606 of interactive test interface 104. In this non-limiting example, add-run-instructions element 602 of run element 604 can be used to require the customized generative response engine to use one or more tool calls in responding to a prompt. This can allow the developer to ensure certain tools are called, which allows the developer to observe how the required tool calls affect the response.

For example, selecting add-run-instructions element 602 in FIG. 6 causes run-instructions entry element 608 to be displayed. A developer interacts with run-instructions entry element 608 to provide various instructions to be performed by customized generative response engine when a prompt is entered in prompt editor 316 and the developer selects run element 604. The customized generative response engine generates a response to the prompt in accordance with the instructions provided in run-instructions entry element 608.

According to certain non-limiting examples, user interface (UI) elements, such as radio buttons, can be used to select one or more tools that are required to be called by the customized generative response engine. The one or more tools can include, for example, a file search tool, a code interpreter tool, an internet browser tool, or a function tool. For example, a first version of the customized generative response engine can lack the given tool, and a new (second) version of the customized generative response engine can be provided by modifying the first version to include the given tool. In this case, a developer may want to verify that the given tool has been properly integrated into the second version of the customized generative response engine. To check this, the developer can provide an input in run-instructions entry element 608 that requires the given tool be exercised when generating the response to the prompt.

According to certain non-limiting examples, an input that adjusts the first configuration into the second configuration of the customized generative response engine can include an input to force the customized generative response engine to use the tool for every turn. Each turn includes a respective prompt and the response generated thereto.

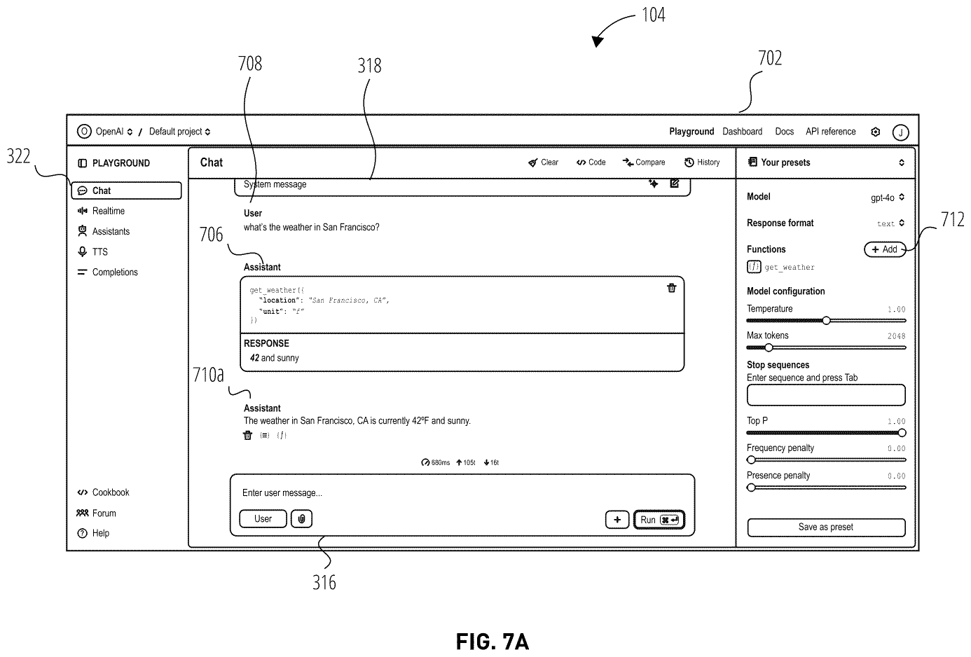

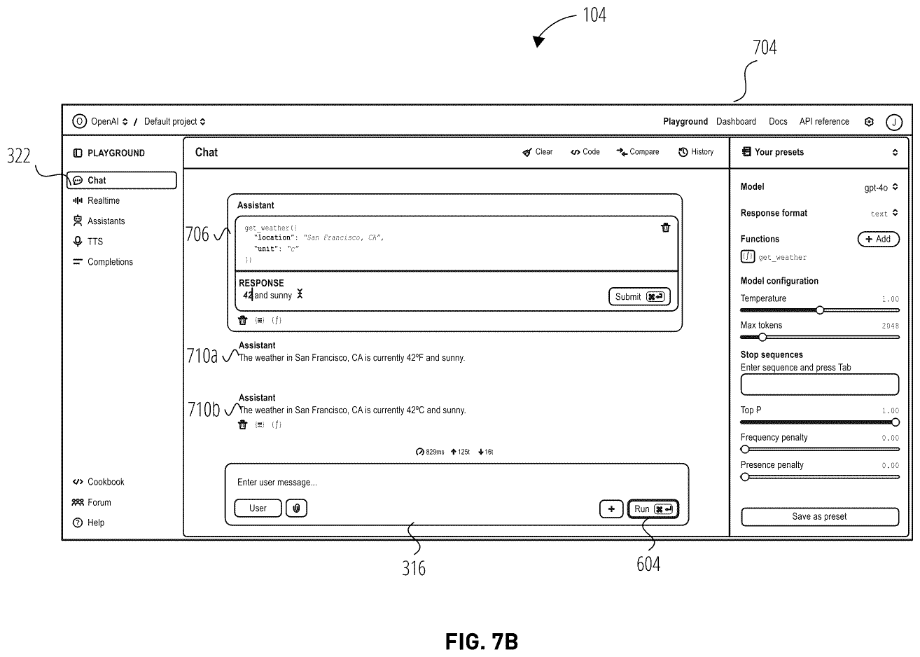

FIGS. 7A and 7B illustrate an example of a function call that is edited directly in the chat history. FIG. 7A illustrates a seventh view 702 of interactive test interface 104 in which chat API 322 is selected. In this non-limiting example, the customized generative response engine includes a function call “get_weather” to return a response providing the weather for a specified location. Add function element 712 can be used to add the get weather function to the customized generative response engine. When the developer enters a prompt “What's the weather in San Francisco?,” and selects run in prompt editor 316, the conversational interface 318 displays user prompt 708, function call 706, and response 710a. The temperature in the function call is in units of “F” (e.g., units of Fahrenheit) and the customized generative response engine provides response 710a in units of “F.”

FIG. 7B illustrates an eighth view 704 of interactive test interface 104 in which chat API 322 is selected. If a developer instead decides that units of “C” (e.g., units of degrees Celsius) are desired for temperature, the developer can directly edit the function in conversational interface 318 to have units of “C” instead of units of “F,” as illustrated in FIG. 7B. Chat API 322 can be stateless such that selecting run element 604 in prompt editor 316 causes the whole history to be sent to the customized generative response engine, and, therefore, the whole history can be modified. After changing the unit and selecting run element 604 again, the customized generative response engine generates response 710b, in which the weather is reported in units of “C.”

Further, the playground environments in interactive test interface 104 can generate fabricated but plausible responses. For example, in FIGS. 7A and 7B, the customized generative response engine does not reach out to an external source (e.g., the Internet) to determine the actual temperature in San Francisco. Instead, the playground environment has the AI model (e.g., gpt-40) fabricate or hallucinate the information in a controlled manner. The playground environments can be used to test aspects of the customized generative response engine, such as the tone and format of the responses, which can be done without depending on the accuracy of the information generated. For example, the tone, format, and other aspects of the operation of the “get_weather” function can be tested without knowing what the actual temperature is in the referenced location (e.g., San Francisco).

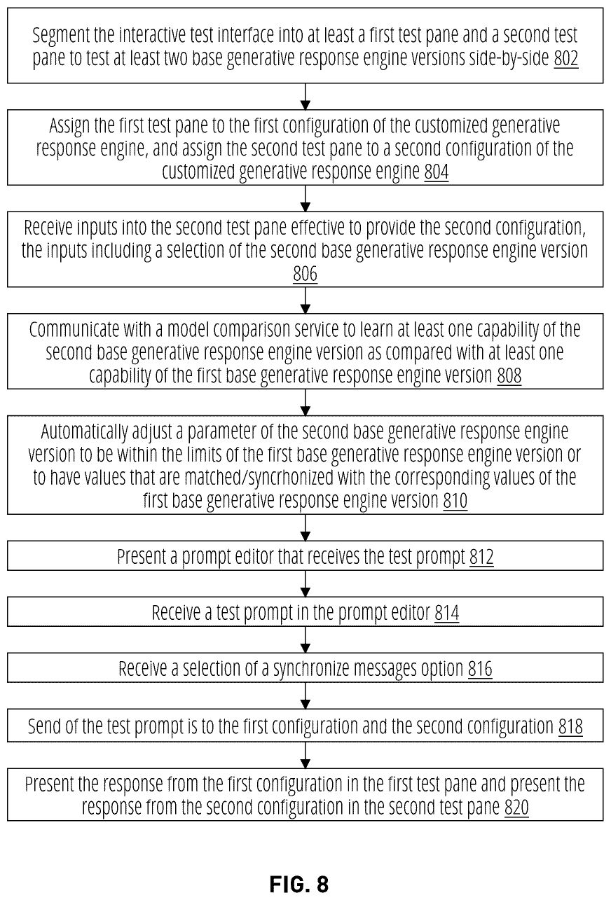

FIG. 8 illustrates an example routine for testing at least two configurations of customized generative response engines side-by-side in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence. Additionally, the routine illustrated in FIG. 8 can be used with any other method addressed herein.

Sometimes, developers will want to test changes to their customized generative response engine against an existing configuration (e.g., a first configuration compared to a second configuration). Often this might be because the developer wants to test a new generation of base generative response engine to see how the configurations of their customized generative response engine work with the new base generative response engine version side-by-side with the existing base generative response engine version, but the interface can also be used to test changes to other parts of the configuration of the customized generative response engine.

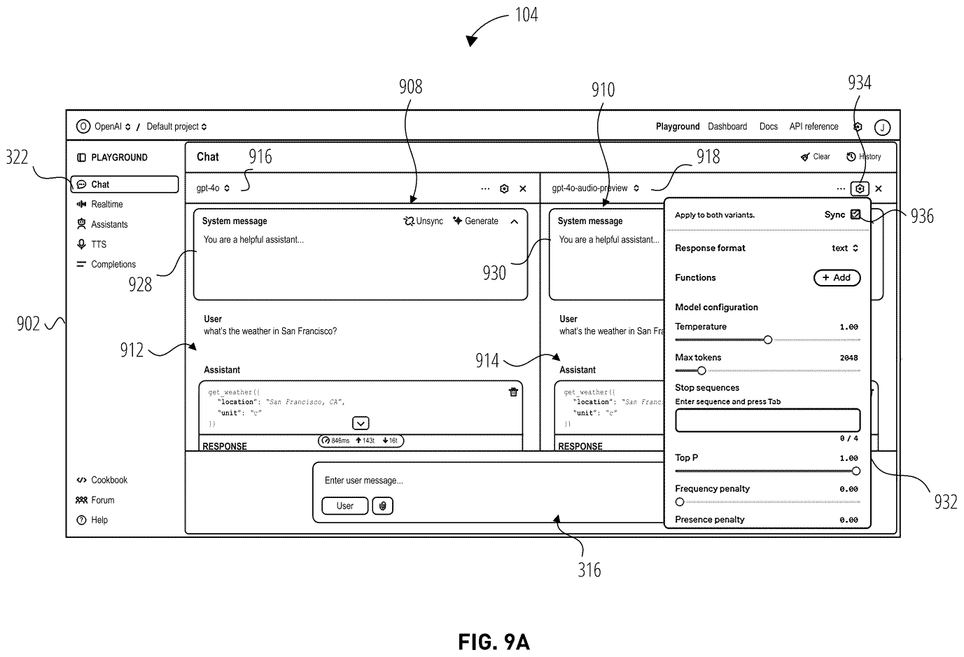

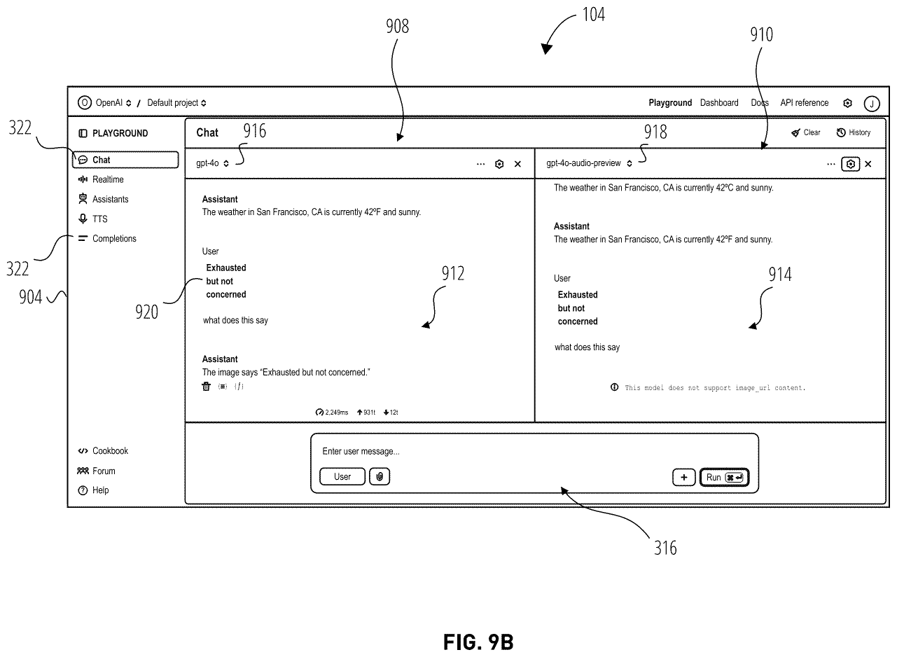

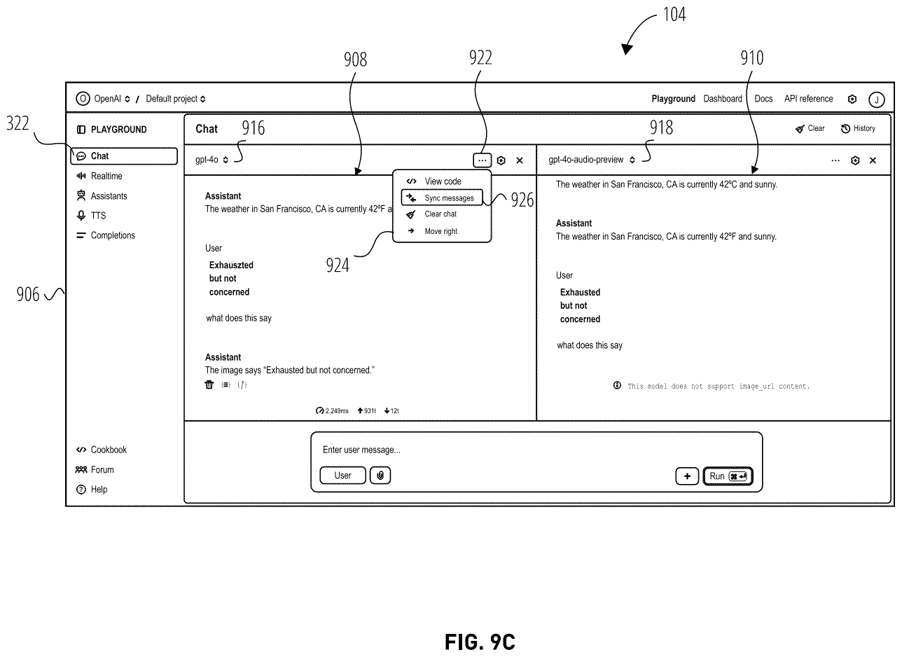

An example of interactive test interface 104 showing first test pane 908 for testing a first configuration of the customized generative response engine and second test pane 910 for testing a second configuration of the customized generative response engine is illustrated in FIGS. 9A-9C.

According to some examples, block 802 of the method includes segmenting the interactive test interface into at least a first test pane and a second test pane to test at least two base generative response engine versions side by side. For example, as illustrated in FIG. 9A, interactive test interface 104 may be segmented into at least a first test pane 908 and a second test pane 910 to test various base generative response engine versions side-by-side. In some examples, there can be “n” test panes corresponding to “n” configurations of the customized generative response engine, wherein “n” is any integer number. If more test panes are used than can fit on a display, a scroll bar can be used to allow scrolling the view among the test panes that cannot fit on the display.

According to some examples, the method includes assigning the first test pane to the first configuration of the customized generative response engine and assigning the second test pane to a second configuration of the customized generative response engine at block 804. For example, in FIG. 9A, first test pane 908 is assigned a first configuration of the customized generative response engine (e.g., the customized generative response engine that uses gpt-40 as its base generative response engine version), and second test pane 910 is assigned to a second configuration of the customized generative response engine (e.g., the customized generative response engine that uses gpt-40-audio-preview as its base generative response engine version).

According to some examples, the method includes receiving inputs into the second test pane effective to provide the second configuration, including a selection of the second base generative response engine version at block 806. For example, second test pane 910 of interactive test interface 104 illustrated in FIG. 9A may receive second base generative response engine version 918 into the second test pane effective to provide the second configuration. Further, as shown in FIG. 9A, the second configuration can be provided using second test pane 910 to receive system instructions in system message 930, and selecting parameter selection option 934 causes parameter selection element 932 to be displayed, allowing a developer to provide the second configuration by adding functions, changing the temperature and max tokens of the model configuration, etc.

In the example interface illustrated in FIG. 9A, the first configuration includes first base generative response engine version 916, and the second configuration includes second base generative response engine version 918. According to certain non-limiting examples, the first configuration can differ from the second configuration with respect to other parameters than the base generative response engine version. However, in some cases, a developer wants to compare the first and second configurations with all parameters being the same except for the base generative response engine versions. In this case, synchronize selector element 936 can be used to synchronize or correlate the parameters between the first configuration and the second configuration. Thus, the developer can compare the configurations for the case in which the second configuration is similar to the first configuration other than the differentiation between the first base generative response engine version of the first configuration and the second base generative response engine version of the second configuration.

Sometimes, two different base generative response engine versions might have different acceptable parameters. For example, it is common that as base generative response engine versions improve, their context window (i.e., the number of tokens they can process as an input) can increase. Thus, when testing a new version, the developer should get better performance out of the newer base generative response engine version by setting the parameters of the second configuration to take advantage of the newer model's increased capability. As will be addressed herein, this can be handled automatically. The example can also work in a direction when the first configuration includes the more capable generative response engine, and the developer wants to test an older, perhaps more cost-effective generative response engine. In this instance, the context window of the newer version can be reduced to the maximum size of the older context window to provide a comparison in which the two versions use the same parameters to the extent possible. This can also happen automatically.

According to some examples, the method includes communicating with a model comparison service to learn at least one capability of the second base generative response engine version as compared with at least one capability of the first base generative response engine version at block 808. For example, when synchronize selector element 936 is selected in interactive test interface 104 illustrated in FIG. 9A, communications can be sent to a model comparison service to learn at least one capability of the second base generative response engine version as compared with at least one capability of the first base generative response engine version. The information received from the model comparison service can be used to synchronize the capabilities of the first version with the capabilities of the second version.

According to some examples, the method includes automatically adjusting a parameter of the second base generative response engine version to be within the limits of the second base generative response engine version at block 810. For example, interactive test interface 104 illustrated in FIG. 9A may automatically adjust a parameter of the second base generative response engine version to be within the limits of the second base generative response engine version or vice versa. The model comparison service is a language model that is trained with knowledge of capabilities of base generative response engine versions and to compare the first base generative response engine version with the second base generative response engine version.

According to some examples, the method includes presenting a prompt editor that is configured to receive the test prompt at block 812. For example, interactive test interface 104 illustrated in FIG. 9A may present a prompt editor 316 that is configured to receive the test prompt. The prompt editor is a common interface to receive the test prompt for both the first configuration of the customized generative response engine and the second configuration of the customized generative response engine.

The first test pane 908 is configured to present responses to the test prompt that are generated by the first configuration of the customized generative response engine, and the second test pane 910 is configured to present responses to the test prompt that are generated by the second configuration of the customized generative response engine.

According to some examples, the method includes receiving a test prompt in the prompt editor at block 814. For example, prompt editor 316 of interactive test interface 104 illustrated in FIG. 9A may receive a test prompt.

According to some examples, the method includes receiving a selection of a synchronize messages option at block 816. For example, sync messages action 926 of interactive test interface 104 illustrated in FIG. 9C may receive a selection of a synchronize messages option. The synchronize message option is presented in at least one of the first test pane and second test pane, wherein the synchronize message option is configured to cause the test prompt received in the prompt editor to be sent to the first configuration and the second configuration simultaneously, whereby a response generation speed of the first configuration and the second configuration can be compared. The first base generative response engine version and the second base generative response engine version are instantiated on separate processing units.

According to some examples, the method includes sending the test prompt to the first configuration and sending the test prompt to the second configuration at block 818. For example, interactive test interface 104 illustrated in FIG. 9A may send the test prompt to the first configuration and send the test prompt to the second configuration.

To compare the speed of the respective version, the first base generative response engine version and the second base generative response engine version are instantiated on separate processing units.

According to some examples, the method includes presenting the response from the first configuration in the first test pane and presenting the response from the second configuration in the second test pane at block 820. For example, interactive test interface 104 illustrated in FIG. 9A may present the response from the first configuration in first test pane 908 and present the response from the second configuration in second test pane 910.

FIGS. 9A-9C illustrate a side-by-side comparison functionality of an interactive test interface 104. The side-by-side comparison functionality allows the developer to observe differences in their customized generative response engine based on which base model is used. Multiple conversational interfaces are displayed side-by-side. Each conversational interface can display the conversation thread for the customized generative response engine using different versions of the base generative response engine.

The side-by-side comparison functionality can be used with different A Pls of the playground. In FIGS. 9A-9C, the side-by-side comparison functionality is illustrated using the according to certain non-limiting example of chat API 322.

FIG. 9A illustrates a ninth view 902 of interactive test interface 104 in which chat API 322 is selected. In this non-limiting example, interactive test interface 104 has two conversational interfaces that are displayed side-by-side: one using gpt-40 as the base generative response engine version and the other using gpt-40-audio-preview as the base generative response engine version.

First test pane 908 displays in conversational interface of first test pane 912 in which is displayed a conversation thread that is generated by the first customized generative response engine, which uses first base generative response engine version 916 (e.g., gpt-40) as the base generative response engine version. The first configuration of the first customized generative response engine is provided, in part, by the system instructions in system message 928. A parameter selection option in the tool bar of first test pane 908 can also be used to provide additional parameters of the model configuration of the first customized generative response engine.

Similarly, second test pane 910 displays in conversational interface of second test pane 914 of a conversation thread that is generated by the second customized generative response engine, which uses second base generative response engine version 918 (e.g., gpt-40-audio-preview) as the base generative response engine version. The second configuration of the second customized generative response engine is provided, in part, by the system instructions in system message 930. Additional parameters of the model configuration of the second customized generative response engine can be set by selecting parameter selection option 934, which causes parameter selection element 932 to be displayed. In parameter selection element 932, functions can be added to, and model configuration parameters (e.g., temperature and max tokens) can be modified for the second customized generative response engine. Synchronize selector element 936 can be used to synchronize the parameters between the respective customized generative response engine. Selecting synchronize selector element 936 causes the parameters to be synchronized between the base generative response engine versions to the degree possible. For example, some aspects and capabilities do not translate between models, in which case these cannot be synchronized.

To have a better apples-to-apples comparison between the base generative response engine versions, it is preferable to have the same values for the model parameters as much as possible. For example, when different sizes are used for the context windows for the base generative response engine versions, the differences between the generated responses may be due to the different-sized context windows rather than due to differences between the base generative response engine versions themselves.

The displayed conversation threads are generated in response to a common prompt entered in prompt editor 316. Because the same prompts are used for both conversation threads, the differences between the conversation threads arise from differences between the respective customized generative response engines. For example, when the only difference between the customized generative response engines is their respective base generative response engine versions, differences between the conversation threads can be attributed to the base generative response engine versions.

FIG. 9B illustrates a tenth view 904 of interactive test interface 104 in which the response in conversational interface of first test pane 912 differs from the response in conversational interface of second test pane 914. Vision tasks such as detecting what is shown in an image are not supported by gpt-40-audio-preview because it is an audio-focused model designed for speech-based interactions, such as transcribing, understanding, and generating spoken language. In contrast, gpt-40 is a multimodal model that supports text, image, and audio inputs. Thus, when the developer attaches image input 920 as an input and enters the prompt “what does this say,” the customized generative response engine using gpt-40 identifies the text shown in image input 920, as shown in the Assistant's response “The image says ‘Exhausted but not concerned.’” in first test pane 908. In contrast, the customized generative response engine using gpt-40-audio-preview fails to identify the text shown in image input 920, as can be seen by the message “This model does not support image_url content” in second test pane 910.

FIG. 9C illustrates an eleventh view 906 of interactive test interface 104 in which a synchronization functionality is demonstrated. To have an apples-to-apples comparison of the relative speeds of the respective customized generative response engines, it is preferable to initiate the customized generative response engines at the same time but on separate processors/hardware to avoid interference in their respective performances.

For example, sync messages action 926 of interactive test interface 104 illustrated in FIG. 9C may receive a selection of a synchronize messages option. The synchronize message option is presented in at least one of the first test pane and second test pane, wherein the synchronize message option is configured to cause the test prompt received in the prompt editor to be sent to the first configuration and the second configuration simultaneously, whereby a response generation speed of the first configuration and the second configuration can be compared. The first base generative response engine version and the second base generative response engine version are instantiated on separate processing units.

In FIG. 9C, a developer selects ellipsis button 922, which causes dropdown menu 924 to be displayed with various actions that can be selected by the developer. Selecting sync messages action 926 causes the test prompt received in the prompt editor to be sent to the first configuration and the second configuration simultaneously, whereby a response generation speed of the first configuration and the second configuration can be compared. The first base generative response engine version and the second base generative response engine version are instantiated on separate processing units.

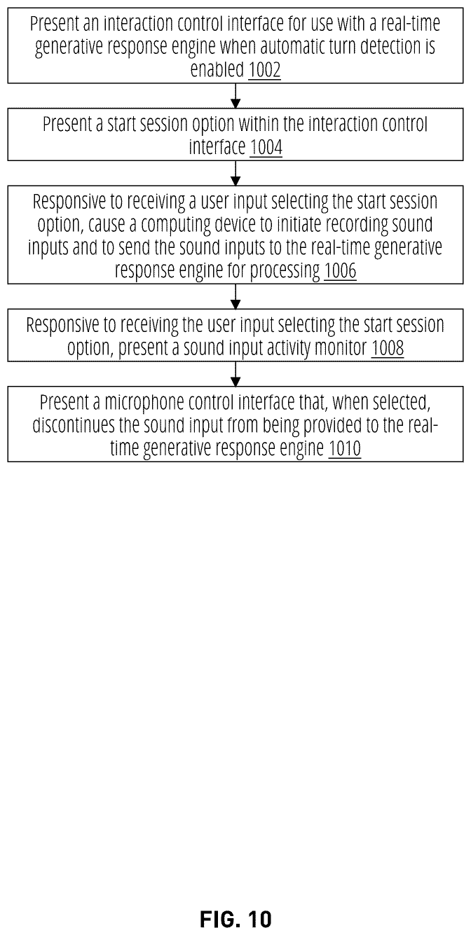

FIG. 10 illustrates an example routine for using an interactive test interface to initialize and control a realtime customized generative response engine to acquire sound and detect speech. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

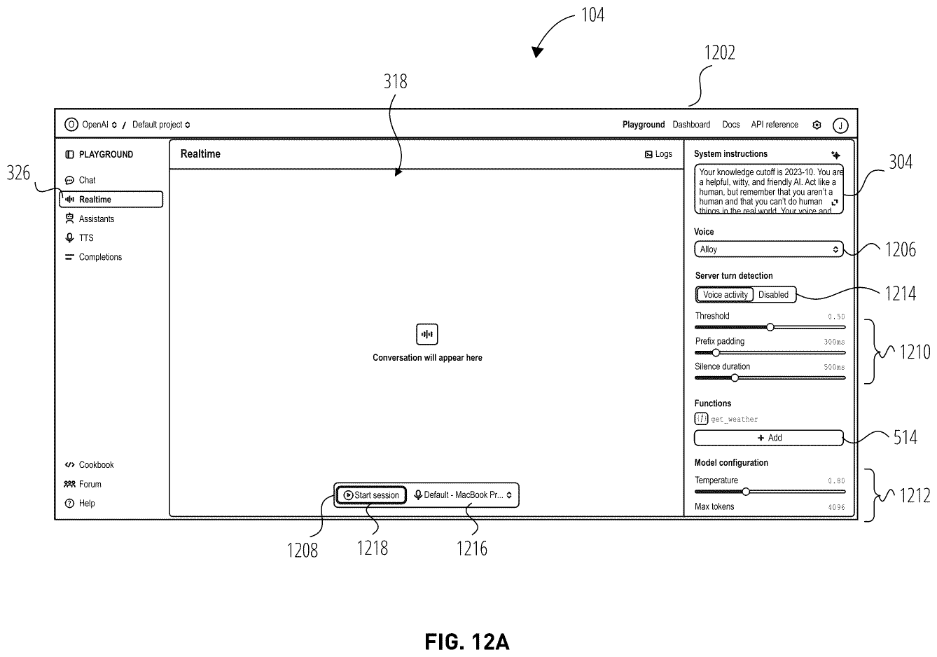

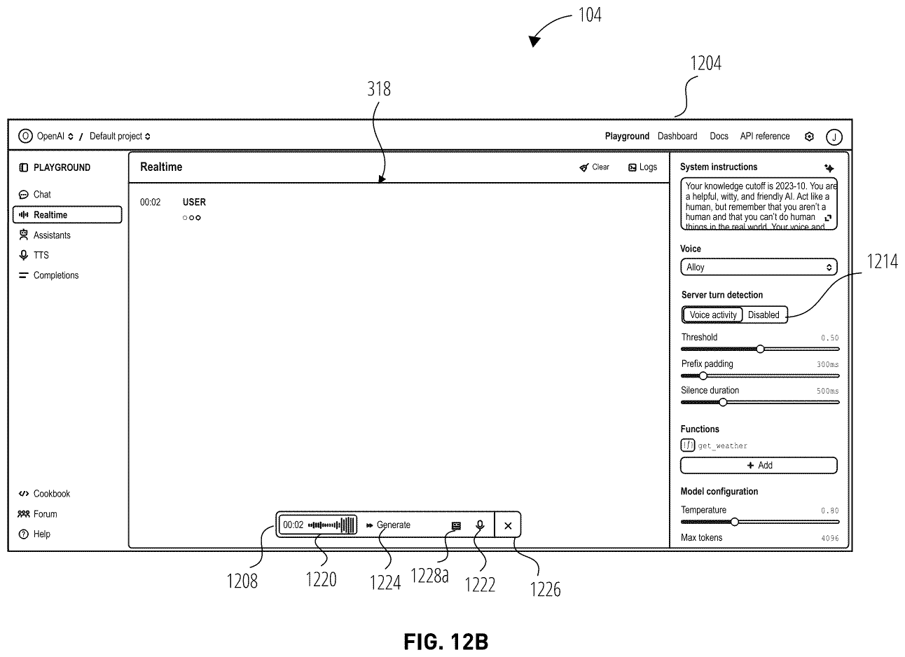

As discussed below, FIG. 12A and FIG. 12B illustrate a non-limiting example of an interactive test interface used to initiate a realtime session and use the appearance of UI elements in control panel 1208 to indicate when sound is being recorded, including using a wave trace to represent an amplitude of the sound (e.g., in decibels (dB)) and using a color of the wave trace to indicate when speech is detected in the sound.

According to some examples, the method includes presenting an interaction control interface for use with a real-time generative response engine when automatic turn detection is enabled at block 1002. For example, interactive test interface 104 illustrated in FIG. 12A may present control panel 1208 for use with a real-time generative response engine when automatic turn detection has been enabled using voice activity/disabled toggle 1214.

According to some examples, the method includes presenting a start session option within the interaction control interface at block 1004. For example, interactive test interface 104 illustrated in FIG. 12A may present start session element 1218 within control panel 1208 of interactive test interface 104.

According to certain non-limiting examples, the interaction control interface is configured to receive inputs that start a real-time communication session (e.g., start session element 1218), that stop or pause the real-time communication session, or that cause the real-time generative response engine to stop generating a particular response, as illustrated in FIG. 12B. For example, selecting generate response element 1224 toggles between the real-time generative response engine being enabled or not enabled to generate responses, and selecting mute element 1222 toggles between the microphone being muted or unmuted. Selecting stop session element 1226 stops the realtime session and returns control panel 1208 to the appearance shown in FIG. 12A.

According to some examples, the method includes that, in response to receiving a developer input selecting the start session option, a computing device is caused to initiate recording sound inputs and to send the sound inputs to the real-time generative response engine for processing at block 1006. For example, interactive test interface 104 illustrated in FIG. 12A may respond to receiving a developer input selecting the start session element 1218 by initiating recording sound inputs and sending the sound inputs to the real-time generative response engine for processing. FIG. 12B shows interactive test interface 104 after the initiation of recording sound inputs and sending the sound inputs to the real-time generative response engine for processing.

According to some examples, the method includes, in response to receiving the developer input selecting the start session option, presenting a sound input activity monitor at block 1008. For example, interactive test interface 104 illustrated in FIG. 12B may respond to receiving the developer input selecting the start session element 1218 by presenting a wave trace in speech detection element 1220 as an animation representing sound input activity, which is presented in a sound input activity monitor. The wave trace in speech detection element 1220 shown in FIG. 12B can be an animation that is correlated to a decibel level of the sound inputs recorded by the computing device. The speech detection element 1220 shown in FIG. 12B can be a sound input activity monitor that replaces a start session option (e.g., start session element 1218) in interactive test interface 104. For example, in FIG. 12B, speech detection element 1220 occupies the same region of control panel 1208 as start session element 1218 occupies in FIG. 12A.

According to some examples, the method includes presenting a microphone control interface that is configured to discontinue providing the sound input to the real-time generative response engine at block 1010. For example, interactive test interface 104 illustrated in FIG. 12B presents mute element 1222, which is a microphone control interface that is configured to discontinue providing the sound input to the real-time generative response engine.

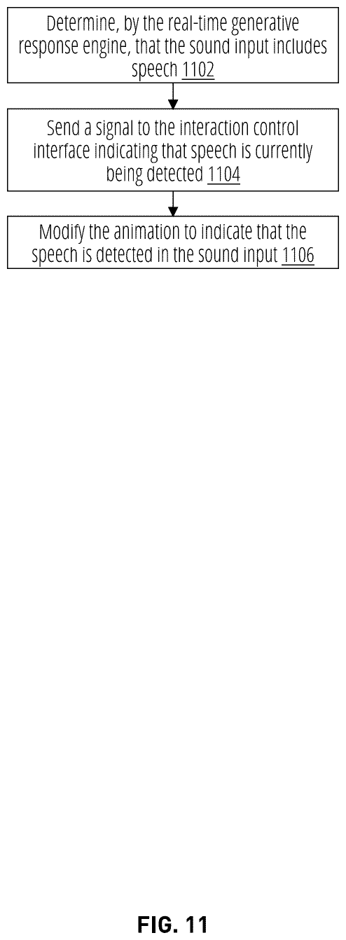

FIG. 11 illustrates an example routine for an interactive test interface of a realtime customized generative response engine in which an appearance of one or more UI elements changes based on the determination whether the input sound includes speech. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes determining, by the real-time customized generative response engine, that the sound input includes speech at block 1102. For example, the wave trace shown in speech detection element 1220 of interactive test interface 104 illustrated in FIG. 12B may change based on a determination by the real-time customized generative response engine that the sound input includes speech.

According to some examples, the method includes sending a flag/signal to the interaction control interface indicating that speech is currently being detected at block 1104. For example, the real-time generative response engine may send a signal that indicates that speech is currently being detected, which then causes interactive test interface 104 to change the appearance of speech detection element 1220.

According to some examples, the method includes modifying the animation to indicate that the speech is detected in the sound input at block 1106. For example, interactive test interface 104 illustrated in FIG. 12B may modify the animation (e.g., the wave trace in speech detection element 1220) to indicate that the speech is detected in the sound input. For example, the animation may be modified by changing a color of the wave trace in speech detection element 1220 from gray to red when speech is detected in the sound input. The wave trace in speech detection element 1220 can be the animation that is correlated to the decibel level of the sound inputs.

FIG. 12A and FIG. 12B illustrate an example of a realtime API functionality in a playground environment. FIG. 12A shows a twelfth view 1202 of interactive test interface 104 in which realtime API 326 is selected. The twelfth view 1202 of interactive test interface 104 includes system message 304, conversational interface 318, add function element 514, voice selection 1206, turn detection configuration 1210, model configuration 1212, voice activity/disabled toggle 1214, microphone selection 1216, and start session element 1218.

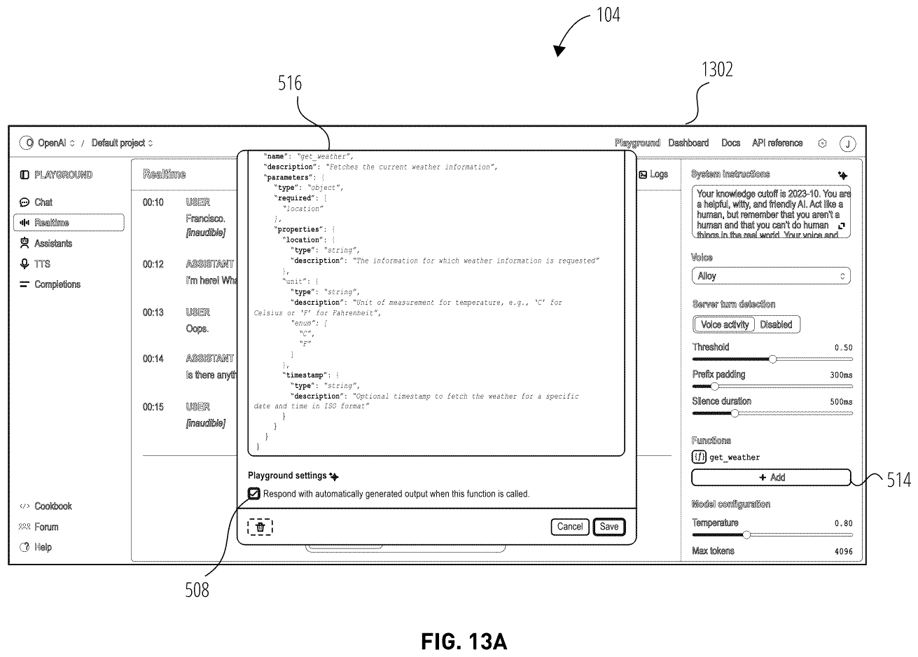

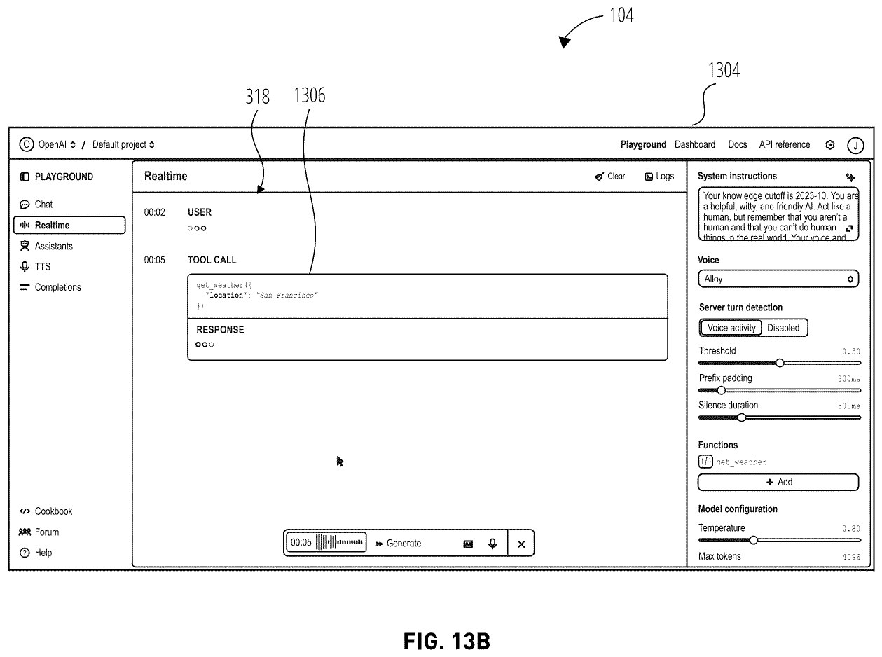

As discussed above, the system instructions field (e.g., system message 304) can be a text box where developers can specify directives to guide the AI's behavior. Conversational interface 318 is where customized generative response engine provides a thread of the back-and-forth conversation. In this case, conversational interface 318 shows a text transcript corresponding to the audio produced/received by the realtime AI (e.g., the customized generative response engine). As discussed above with reference to FIG. 5B, add function element 514 is used to add functions to the customized generative response engine. FIG. 13A and FIG. 13B provided additional information about add function element 514 in realtime API 326.

Voice selection 1206 can be used to select the version of voice used by the realtime AI. For example, the selected voice can be male or female, have different accents, and set have different attributes (e.g., smooth, adventurous, playful, etc.). For example, REALTIME API from OPENAI can offer a selection of voices for speech-to-speech interactions. Examples of the voices can include, but are not limited to, Ash, Ballad, Coral, Sage, Verse, Alloy, Echo, Onyx, and Shimmer.

Turn detection configuration 1210 provides settings that can be used to determine when the developer is done speaking and the realtime AI has an opening in the conversation to respond.

In the OpenAI Realtime API, turn detection refers to identifying when a developer has finished speaking, allowing the system to process and respond appropriately. For example, REALTIME API from OPENAI provides parameters for creating natural, conversational experiences in voice-interactive applications. The turn detection types can be server voice activity detection (VAD) or none. Server VAD can use server-side algorithms to detect speech boundaries based on audio input characteristics. When selecting none, automatic turn detection is disabled, requiring manual management of speech input processing. The parameters used for the turn detection configuration can include, but are not limited to, threshold, prefix padding, silence duration, and create response. The threshold parameter sets the sensitivity level for detecting speech activity; higher values make the system more responsive to quieter sounds. The prefix padding parameter introduces a delay before processing begins after detecting speech, allowing for natural pauses. The silence duration parameter defines how long the system waits after detecting the end of speech before initiating a response, accommodating brief pauses in conversation. The create response parameter determines whether the system should automatically generate a response after detecting speech, facilitating seamless conversational flow.

Model configuration 1212 in realtime API 326 can specify the settings that control how the model interacts with input and generates output, including, but not limited to, parameters like model selection, temperature, and max tokens, which are used to customize the behavior of the language model. These configurations allow fine-tuning of the model's response style, accuracy, and performance in real-time interactions.

Voice activity/disabled toggle 1214 allows voice activation to be turned on and off. For example, while a developer may be developing parts of the customized generative response engine, they may not want the realtime AI model responding to ambient conversations.

Microphone selection 1216 indicates the microphone being used to acquire the audio signals. Start session element 1218 is used to start a realtime session.

In FIG. 12A and FIG. 12B, voice activity/disabled toggle 1214 has been toggled to enable voice activity. With voice activity enabled, the microphone picks up the surrounding sound and translates the detected speech to text, which is received as the prompt from the developer.

FIG. 12B shows a thirteenth view 1204 of interactive test interface 104 in which a session has been started by selecting start session element 1218 in realtime API 326. After the realtime session has stated, control panel 1208 displays speech detection element 1220, mute element 1222, generate response element 1224, and stop session element 1226. Stop session element 1226 stops the realtime session. Mute element 1222 allows the developer to mute the microphone. open text window element 1228a causes a text entry element/box to be displayed, and a prompt can be entered using the text entry element/box. The prompt is added to the conversation thread such that the realtime AI can generate a response to the prompt. Generate response element 1224 changes in appearance to indicate when the realtime AI is generating a response. Developers can select or deselect generate response element 1224 to control whether the realtime AI generates responses.

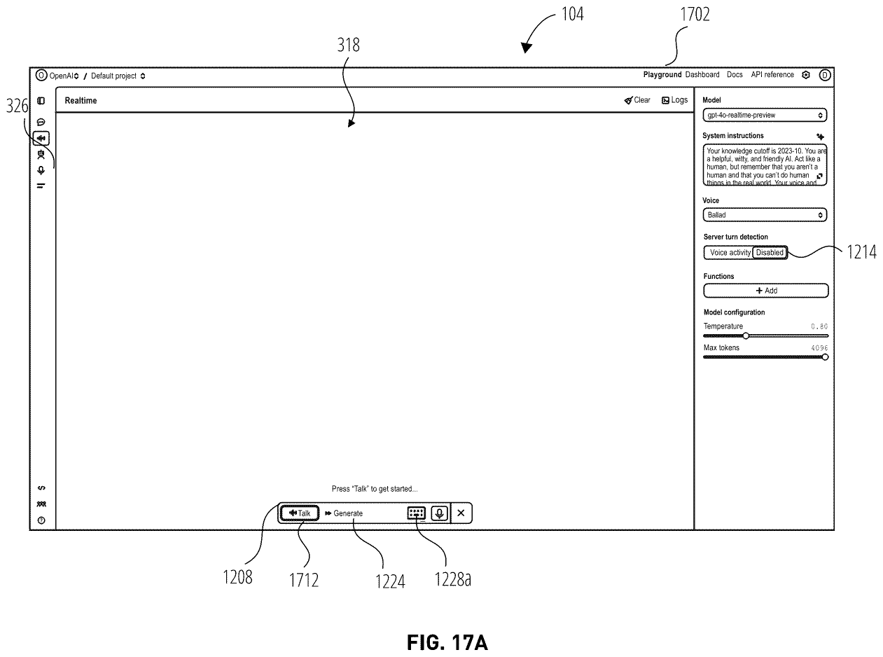

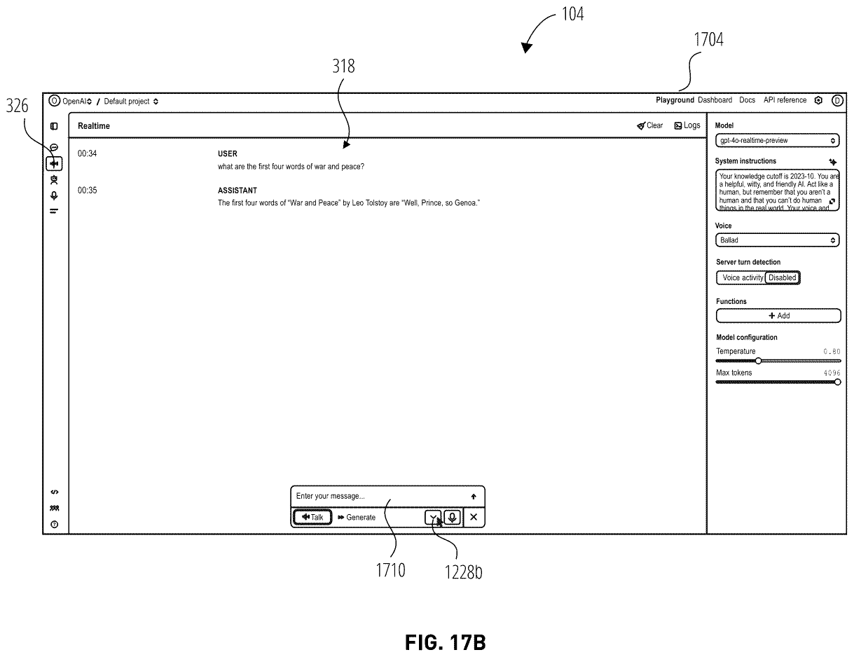

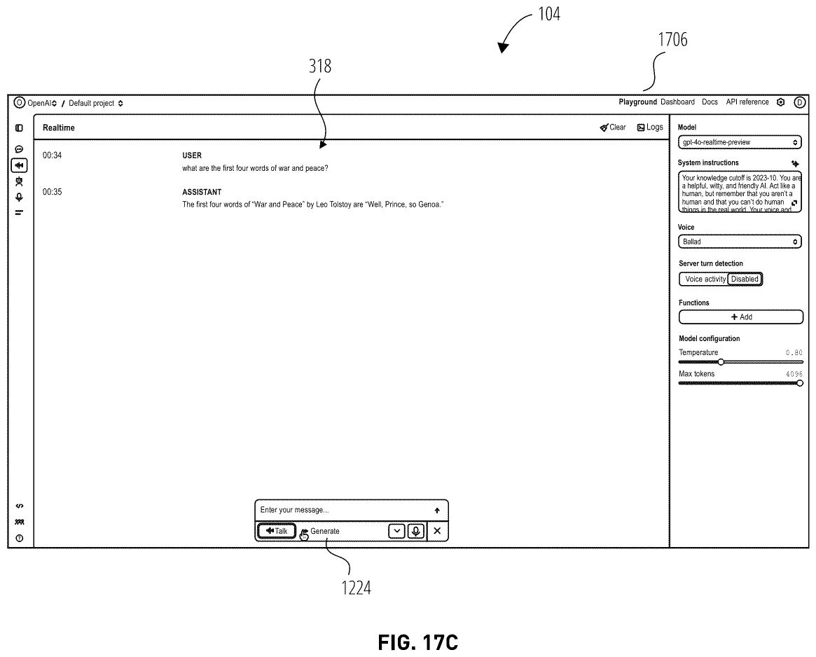

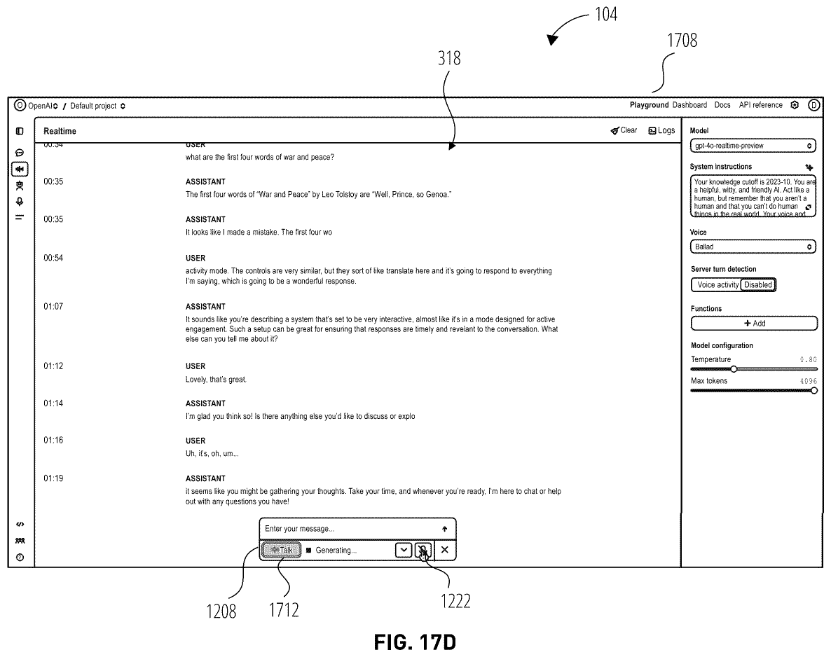

When voice activity is enabled by toggling voice activity/disabled toggle 1214, speech detection element 1220 is displayed. Speech detection element 1220 shows a timer and a wave trace representing the detected audio signal. According to certain non-limiting examples, when the audio signal is determined to be speech, the wave trace shown in speech detection element 1220 will change color (e.g., change to red) as opposed to the default color (e.g., gray), which is displayed for ambient noise without detectable speech. The detected speech becomes the prompt to which the realtime AI generates a response. The response is output as speech and text for the response is also shown in conversational interface 318 together with the prompts. A transcript of the conversation is displayed in conversational interface 318, as illustrated in FIG. 17C and FIG. 17D.

FIG. 13A and FIG. 13B illustrate tool-call functionality in realtime API 326. FIG. 13A shows a fourteenth view 1302 of interactive test interface 104 in which realtime API 326 is selected. The customized generative response engine to use one or more tool calls in responding to a prompt. The one or more tools can include, for example, a file search tool, a code interpreter tool, an internet browser tool, or a function tool. FIG. 13A illustrates using add function element 514 to add a function call to the customized generative response engine. Selecting add function element 514 causes 516 to be displayed. A developer can then write code in code entry element 516 to define the function. Additionally or alternatively, the developer can select generate element 508 in code entry element 516 to cause a text entry element (e.g., text entry element 510) to be displayed. A plain language description of the desired functionality can be entered in the text entry element and an AI code generator will generate code with the described functionality and display the AI-generated code in code entry element 516. The developer can then edit the AI-generated code in code entry element 516.

The system comprises an interactive test interface 104, a generate element 508, an add function element 514, a code entry element 516, and a fourteenth view 1302.

FIG. 13B shows a fifteenth view 1304 of interactive test interface 104 in which realtime API 326 is selected, in which function call 1306 is displayed in conversational interface 318. For example, after the customized generative response engine calls the function, conversational interface 318 can display function call 1306.

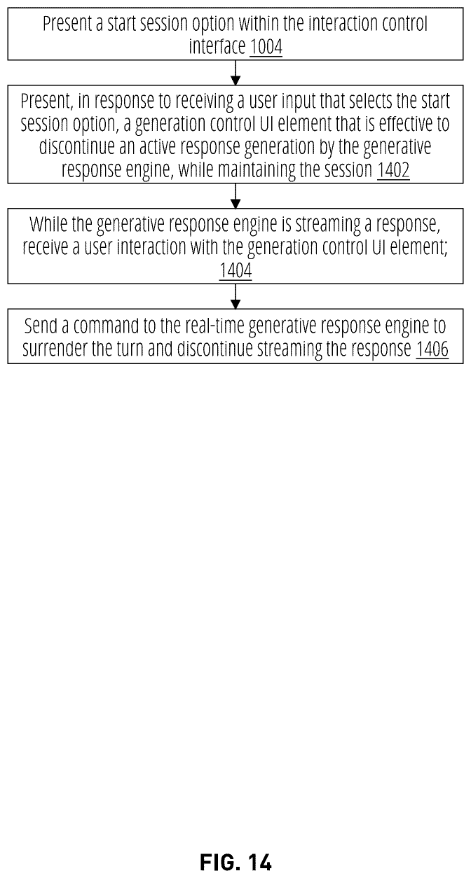

FIG. 14 illustrates an example routine for using an interactive test interface to start a realtime session and control response generation by a realtime customized generative response engine. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes presenting a start session option within the interaction control interface at block 1004. For example, interactive test interface 104 illustrated in FIG. 12A may present start session element 1218 in control panel 1208 as a start session option within interactive test interface 104.

According to some examples, the method includes responsive to receiving a developer input selecting the start session option, presenting a generation control UI element that is effective to discontinue an active response generation by the generative response engine, while maintaining the session at block 1402. For example, interactive test interface 104 illustrated in FIG. 17A and FIG. 17C may respond to receiving the selection of start session element 1218 by presenting generate response element 1224 as a generation control UI element that is effective to discontinue an active response generation by the generative response engine while maintaining the session.

According to some examples, block 1404 of the method includes receiving a developer input interacting with the generation control UI element while the generative response engine is streaming a response. For example, while the realtime customized generative response engine is streaming a response, interactive test interface 104 illustrated in FIG. 17C may receive a developer's input selecting generate response element 1224.

According to some examples, the method includes sending a command to the real-time generative response engine to discontinue streaming the response and to surrender the turn at block 1406. For example, the selection of generate response element 1224 in interactive test interface 104 illustrated in FIG. 17C causes the real-time customized generative response engine to suspend generating the response, even when the response is only partially generated. Selecting 1224 a second time can cause the realtime customized generative response engine to resume generating the response. Entering another prompt while the current response is suspended causes the real-time customized generative response engine to respond to the new prompt. The real-time customized generative response engine can generate a response based on the entirety of the conversational thread within the context window. For example, when the real-time customized generative response engine has completed generating a response, and no additional prompt has been provided, selecting generate response element 1224 can cause the real-time customized generative response engine to generate an additional response based on the content in the context window.

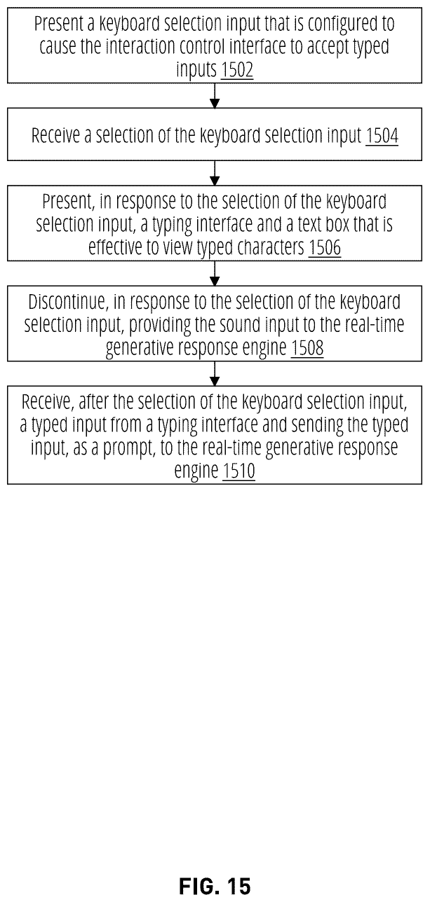

FIG. 15 illustrates an example routine for using a typing interface to enter prompts in an interactive test interface for a real-time customized generative response engine. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes presenting a keyboard selection input that is configured to cause the interaction control interface to accept typed inputs at block 1502. For example, interactive test interface 104 illustrated in FIG. 17A may present open text window element 1228a as a keyboard selection input that is configured to cause interactive test interface 104 to accept typed inputs.

According to some examples, the method includes receiving a selection of the keyboard selection input at block 1504. For example, interactive test interface 104 illustrated in FIG. 17C may receive a selection of open text window element 1228a.

According to some examples, after the selection of the keyboard input, the method includes presenting a typing interface and a text box that is effective for viewing typed characters at block 1506. For example, after the selection of the keyboard input, interactive test interface 104 illustrated in FIG. 17B may present text entry element 1710 as a typing interface and a text box that is effective view typed characters.

According to some examples, the method includes after the selection of the keyboard selection input, discontinuing the providing the sound input to the real-time generative response engine at block 1508. For example, after the selection of the keyboard selection input, interactive test interface 104 illustrated in FIG. 17B may discontinue providing sound input to the real-time generative response engine.

According to some examples, block 1510 of the method includes receiving inputs from a typing interface and sending the inputs to the real-time generative response engine as a prompt, after the selection of the keyboard selection input. For example, after the selection of the keyboard selection input, interactive test interface 104 illustrated in FIG. 17B may receive an input that is typed using text entry element 1710 as a typing interface, and interactive test interface 104 can send the received inputs to the real-time generative response engine as a prompt.

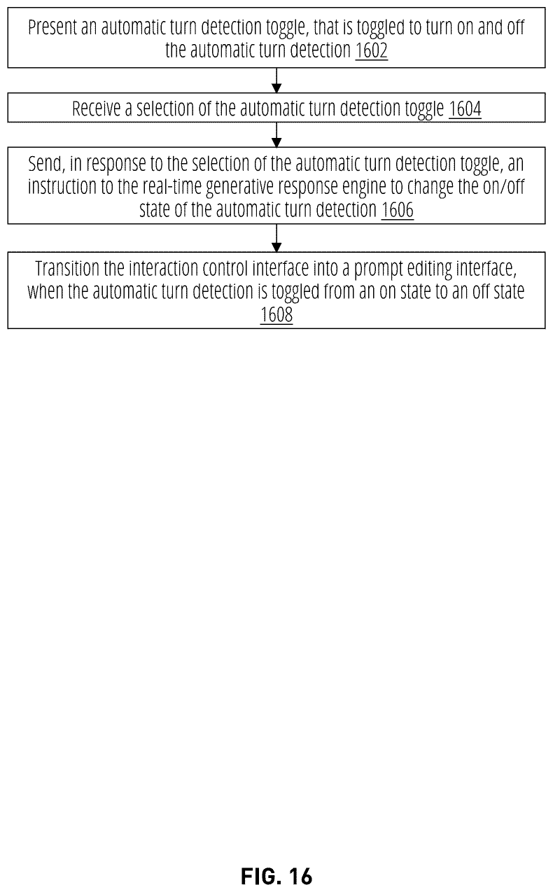

FIG. 16 illustrates an example routine for developing and testing a realtime customized generative response engine using an automatic turn detection functionality. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes presenting an automatic turn detection toggle at block 1602. According to certain non-limiting examples, the automatic turn detection toggle can be configured to turn on and turn off the automatic turn detection. For example, interactive test interface 104 illustrated in FIG. 17A and FIG. 12B presents an automatic turn detection toggle (e.g., voice activity/disabled toggle 1214) that turns on and off the automatic turn detection based on user interactions.

According to some examples, the method includes receiving a selection of the automatic turn detection toggle at block 1604. For example, automatic turn detection can be turned on by receiving a selection of the automatic turn detection toggle in which a developer selects a part of voice activity/disabled toggle 1214 that is labeled “voice activity” in interactive test interface 104 illustrated in FIG. 17A. Alternatively, automatic turn detection can be turned off by receiving a selection of the automatic turn detection toggle in which a developer selects a part of voice activity/disabled toggle 1214 that is labeled “disabled” in interactive test interface 104 illustrated in FIG. 17A.

According to some examples, the method includes sending an instruction to the real-time generative response engine to turn on/off automatic turn detection at block 1606. For example, interactive test interface 104 illustrated in FIG. 17A may send an instruction to the real-time generative response engine to turn on/off automatic turn detection.

According to some examples, the method includes transitioning the interaction control interface into a prompt editing interface at block 1608. For example, when interactive test interface 104 has automatic turn detection turned on, selecting the part of voice activity/disabled toggle 1214 that is labeled “disabled” causes interactive test interface 104 to transition from a voice activity mode into a prompt editing mode. Similarly, when interactive test interface 104 has automatic turn detection turned off, selecting the part of voice activity/disabled toggle 1214 that is labeled “voice activity” causes interactive test interface 104 to transition from a prompt editing mode into a voice activity mode.

FIGS. 17A-17D illustrate examples of various functionalities of the playground environment using realtime API 326 in which automatic turn detection has been disabled (e.g., by selecting the part of voice activity/disabled toggle 1214 that is labeled “disabled”). FIG. 17A shows a sixteenth view 1702 of interactive test interface 104 in which realtime API 326 is selected. A developer can enter a prompt using either text or voice. A prompt can be entered via text by selecting open text window element 1228a, which causes 1710 to be displayed. A prompt can be entered via voice by selecting talk control 1712, which causes voice inputs to be received and causes speech detection element 1220 illustrated in FIG. 1220 to be displayed. Selecting speech detection element 1220 discontinues receiving voice inputs, and returns talk control 1712 in place of speech detection element 1220.

FIG. 17B shows a seventeenth view 1704 of interactive test interface 104 in which realtime API 326 is selected. A developer can enter a prompt using text, as opposed to voice, by selecting open text window element 1228a. Selecting open text window element 1228a causes text entry element 1710 and close text window element 1228b to be displayed, and the developer types their prompt in text entry element 1710 and presses enter, after which the customized generative response engine generates a response. Both the prompt and the response are displayed in conversational interface 318. When it is no longer wanted, selecting close text window element 1228b causes text entry element 1710 to stop being displayed and replaces close text window element 1228b with open text window element 1228a.

FIG. 17C shows an eighteenth view 1706 of interactive test interface 104 in which realtime API 326 is selected. When a prompt is entered, the customized generative response engine automatically starts generating a response, which is conveyed via text in conversational interface 318 and via generated speech. According to certain non-limiting examples, selecting generate response element 1224 stops the customized generative response engine from generating the response to the prompt. Deselecting generate response element 1224 (e.g., clicking generate response element 1224 a second time) causes the customized generative response engine to resume generating the response to the prompt. In FIG. 17C voice activity is disabled. While voice activity is disabled, the realtime customized generative response engine is limited to responding to prompts generated by typing in text entry element 1710. In contrast, when voice activity is enabled, the customized generative response engine automatically determines when the turns occur (e.g., when to respond to received speech and when to listen while the user is speaking), as illustrated above in FIG. 12A and FIG. 12B.

FIG. 17D shows a nineteenth view 1708 of interactive test interface 104 in which realtime API 326 is selected. Selecting mute element 1222 of control panel 1208 mutes the microphone. When the microphone is muted, talk control 1712 is grayed out and disabled because input sound/speech cannot be received while the microphone is muted.

FIG. 17D shows an example of a conversation thread between the developer and the realtime AI. When the developer's speech is directed toward another person rather than the realtime AI, the developer can select mute element 1222 to prevent the realtime AI from responding to this extraneous conversations.

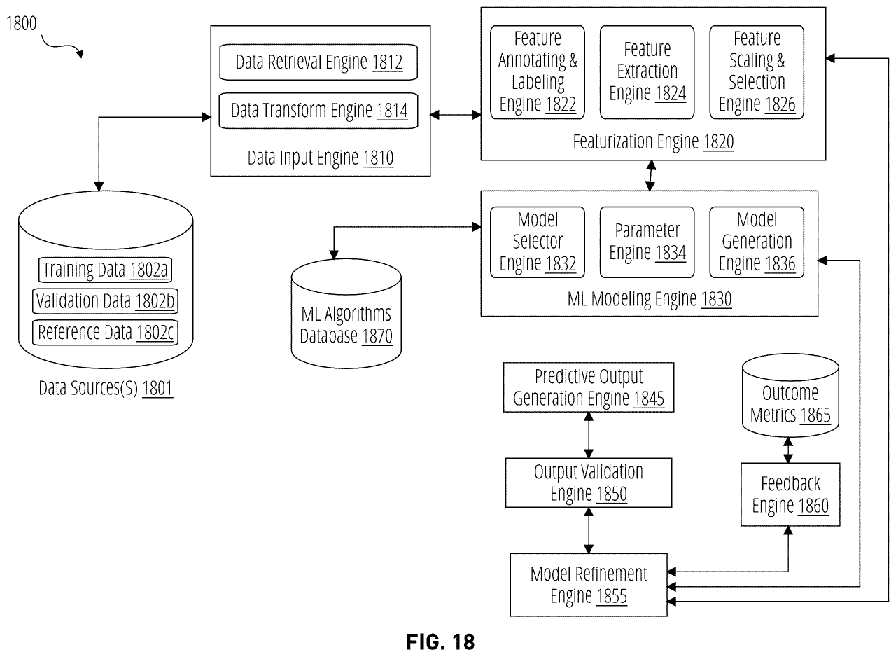

FIG. 18 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 1800 may include data input engine 1810 that can further include data retrieval engine 1812 and data transform engine 1814. Data retrieval engine 1812 may be configured to access, interpret, request, or receive data, which may be adjusted, reformatted, or changed (e.g., to be interpretable by another engine, such as data input engine 1810). For example, data retrieval engine 1812 may request data from a remote source using an API. Data input engine 1810 may be configured to access, interpret, request, format, re-format, or receive input data from data sources(s) 1801. For example, data input engine 1810 may be configured to use data transform engine 1814 to execute a re-configuration or other change to data, such as a data dimension reduction. In some embodiments, data sources(s) 1801 may be associated with a single entity (e.g., organization) or with multiple entities. Data sources(s) 1801 may include one or more of training data 1802a (e.g., input data to feed a machine learning model as part of one or more training processes), validation data 1802b (e.g., data against which at least one processor may compare model output with, such as to determine model output quality), and/or reference data 1802c. In some embodiments, data input engine 1810 can be implemented using at least one computing device. For example, data from data sources(s) 1801 can be obtained through one or more I/O devices and/or network interfaces. Further, the data may be stored (e.g., during execution of one or more operations) in a suitable storage or system memory. Data input engine 1810 may also be configured to interact with a data storage, which may be implemented on a computing device that stores data in storage or system memory.

System 1800 may include featurization engine 1820. Featurization engine 1820 may include feature annotating & labeling engine 1822 (e.g., configured to annotate or label features from a model or data, which may be extracted by feature extraction engine 1824), feature extraction engine 1824 (e.g., configured to extract one or more features from a model or data), and/or feature scaling & selection engine 1826 Feature scaling & selection engine 1826 may be configured to determine, select, limit, constrain, concatenate, or define features (e.g., AI features) for use with AI models.

System 1800 may also include machine learning (ML) ML modeling engine 1830, which may be configured to execute one or more operations on a machine learning model (e.g., model training, model re-configuration, model validation, model testing), such as those described in the processes described herein. For example, ML modeling engine 1830 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 1802a) through a machine learning model process (e.g., a training process). In some embodiments, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, billions, or even trillions of model parameters. ML modeling engine 1830 may include model selector engine 1832 (e.g., configured to select a model from among a plurality of models, such as based on input data), parameter engine 1834 (e.g., configured to add, remove, and/or change one or more parameters of a model), and/or model generation engine 1836 (e.g., configured to generate one or more machine learning models, such as according to model input data, model output data, comparison data, and/or validation data).

In some embodiments, model selector engine 1832 may be configured to receive input and/or transmit output to M L algorithms database 1870. Similarly, featurization engine 1820 can utilize storage or system memory for storing data and can utilize one or more I/O devices or network interfaces for transmitting or receiving data. ML algorithms database 1870 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2V ec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 1870 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 1870 include versions DALL. E, CHAT GPT, and SORA, all provided by OPEN AI.

System 1800 can further include predictive output generation engine 1845 and output validation engine 1850 (e.g., configured to apply validation data to machine learning model output). Predictive output generation engine 1845 can analyze the input and identify relevant patterns and associations in the data it has learned to generate a sequence of words that predictive output generation engine 1845 predicts is the most likely continuation of the input using one or more models from the M L algorithms database 1870, aiming to provide a coherent and contextually relevant answer. Predictive output generation engine 1845 generates responses by sampling from the probability distribution of possible words and sequences, guided by the patterns observed during its training. In some embodiments, predictive output generation engine 1845 can generate multiple possible responses before presenting the final one. Predictive output generation engine 1845 can generate multiple responses based on the input, and these responses are variations that predictive output generation engine 1845 considers potentially relevant and coherent. Output validation engine 1850 can evaluate these generated responses based on certain criteria. These criteria can include relevance to the prompt, coherence, fluency, and sometimes adherence to specific guidelines or rules, depending on the application. Based on this evaluation, output validation engine 1850 selects the most appropriate response. This selection is typically the one that scores highest on the set criteria, balancing factors like relevance, informativeness, and coherence.

System 1800 can further include feedback engine 1860 (e.g., configured to apply feedback from a user and/or machine to a model) and model refinement engine 1855 (e.g., configured to update or re-configure a model). In some embodiments, feedback engine 1860 may receive input and/or transmit output (e.g., output from a trained, partially trained, or untrained model) to outcome metrics database 1865. Outcome metrics database 1865 may be configured to store output from one or more models and may also be configured to associate output with one or more models. In some embodiments, outcome metrics database 1865, or other device (e.g., model refinement engine 1855 or feedback engine 1860), may be configured to correlate output, detect trends in output data, and/or infer a change to input or model parameters to cause a particular model output or type of model output. In some embodiments, model refinement engine 1855 may receive output from predictive output generation engine 1845 or output validation engine 1850. In some embodiments, model refinement engine 1855 may transmit the received output to featurization engine 1820 or ML modeling engine 1830 in one or more iterative cycles.

The engines of system 1800 may be packaged functional hardware units designed for use with other components or a part of a program that performs a particular function (e.g., of related functions). Any or each of these modules may be implemented using a computing device. In some embodiments, the functionality of system 1800 may be split across multiple computing devices to allow for distributed processing of the data, which may improve output speed and reduce computational load on individual devices. In some embodiments, system 1800 may use load-balancing to maintain stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 1800 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

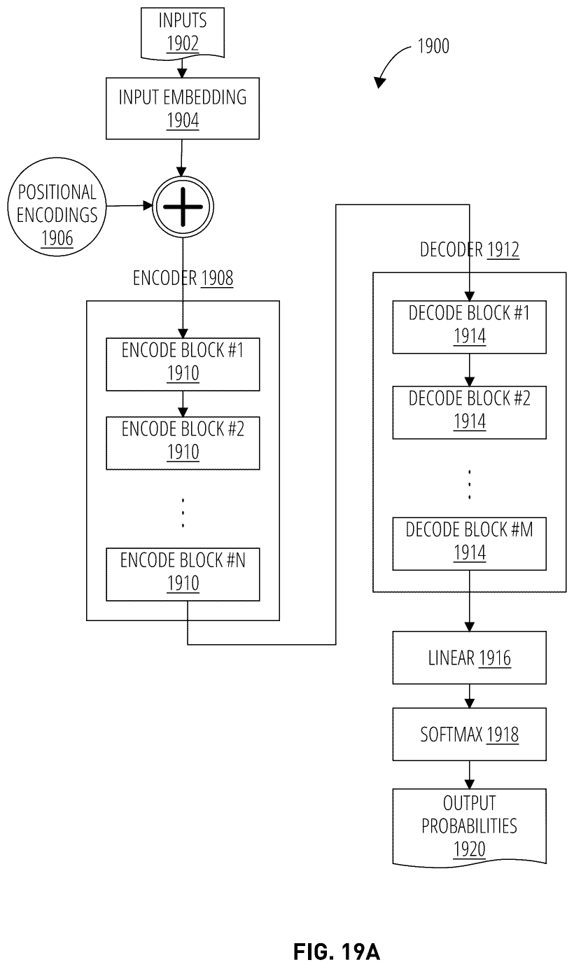

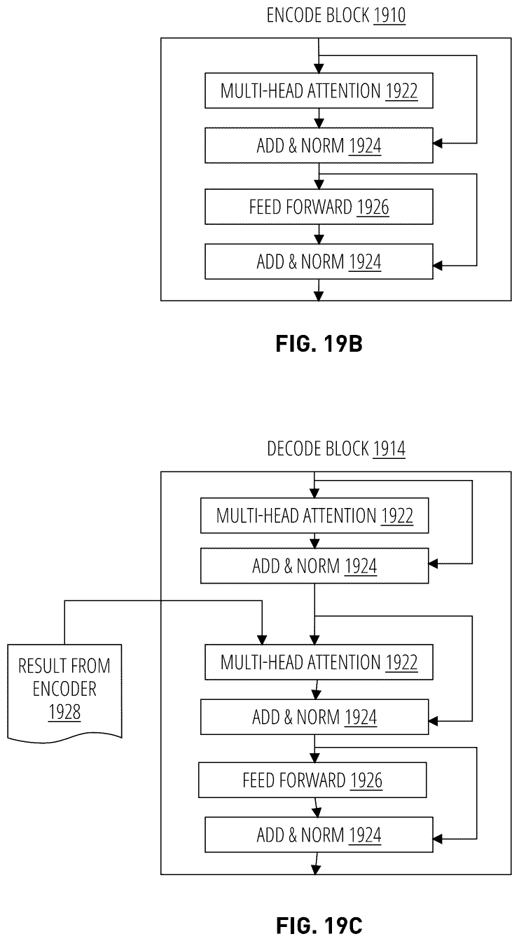

FIG. 19A, FIG. 19B, and FIG. 19C illustrates an example transformer architecture in accordance with some embodiments of the present technology. Examples of ML models that use a transformer neural network (e.g., transformer architecture 1900) can include, e.g., generative pretrained transformer (GPT) models and Bidirectional Encoder Representations from Transformer (BERT) models. The transformer architecture 1900, which is illustrated in FIG. 19A, FIG. 19B, and FIG. 19C, includes inputs 1902, input embedding block 1904, positional encodings 1906, encoder 1908 including encode blocks 1910, decoder 1912 including decode blocks 1914, linear block 1916, softmax block 1918, and output probabilities 1920.

Input embedding block 1904 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 1904 can be learned embeddings to convert the input tokens and output tokens to vectors of dimension that have the same dimension as the positional encodings, for example.

Positional encodings 1906 provide information about the relative or absolute position of the tokens in the sequence. According to certain non-limiting examples, positional encodings 1906 can be provided by adding positional encodings to the input embeddings at the inputs to the encoder 1908 and decoder 1912. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 1908 can use stacked self-attention and point-wise, fully connected layers. Encoder 1908 can be a stack of N identical layers (e.g., N=6), and each layer can be an encode block, as illustrated by encode block 1910 shown in FIG. 19B. Each encode block 1910 has two sub-layers: (i) a first sub-layer has a multi-head attention block 1922 and (ii) a second sub-layer has a feed forward block 1926, which can be a position-wise fully connected feed-forward network. The feed forward block 1926 can use a rectified linear unit (ReLU).

Encoder 1908 uses a residual connection around each of the two sub-layers, followed by an add & norm block 1924, which performs normalization. For example, the output of each sub-layer can be LayerNorm (x+Sublayer (x)). To facilitate these residual connections, all sub-layers in the model, as well as the embedding layers, produce output data having a same dimension.

Similar to encoder 1908, decoder 1912 uses stacked self-attention and point-wise, fully connected layers. Decoder 1912 can also be a stack of M identical layers (e.g., M=6), and each layer can be a decode block, as illustrated by decode block 1912 shown in FIG. 19B. In addition to the two sub-layers (i.e., the sublayer with multi-head attention block 1922 and the sub-layer with feed forward block 1926) found in encode block 1910, decode block 1914 can include a third sub-layer, which performs multi-head attention over the output of the encoder stack. Similar to encoder 1908, decoder 1912 uses residual connections around each of the sub-layers, followed by layer normalization. Additionally, the sub-layer with multi-head attention block 1922 can be modified in the decoder stack to prevent positions from attending to subsequent positions. This masking, combined with the fact that the output embeddings are offset by one position, can ensure that the predictions for position i can depend only on the known output data at positions less than i.

Linear block 1916 can be a learned linear transformation. For example, when transformer architecture 1900 is being used to translate from a first language into a second language, linear block 1916 can project the output from the last decode softmax block 1918 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 1918 then turns the scores from linear block 1916 into output probabilities 1920 (which add up to 1.0). In each position, the index provides for the word with the highest probability, and then maps that index to the corresponding word in the vocabulary. Those words then form the output sequence of transformer architecture 1900. The softmax operation is applied to the output from linear block 1916 to convert the raw numbers into output probabilities 1920 (e.g., token probabilities).

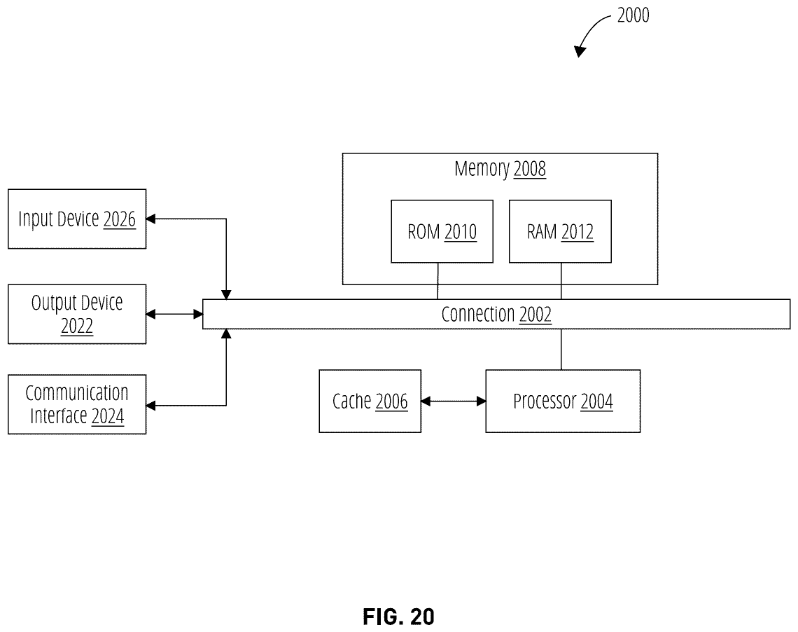

FIG. 20 shows an example of computing system 2000, which can be, For example, any computing device making up any engine illustrated in FIG. 1 or any component thereof.

In some embodiments, computing system 2000 is a single device, or a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

In some embodiments, computing system 2000 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 2000 includes at least one processing unit (CPU or processor) 2004 and connection 2002 that couples various system components including system memory 2008, such as read-only memory (ROM) 2010 and random access memory (RAM) 2012 to processor 2004. Memory 2008 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAM s), read-only memory (ROM), and/or some combination of these devices.

Memory 2008 can include software services, servers, logic, etc., that when the code that defines such software is executed by the processor 2004, it causes the system to perform a function. In some embodiments, a hardware service that performs a particular function can include the software component stored in a computer-readable medium in connection with the necessary hardware components, such as processor 2004, connection 2002, output device 2022, etc., to carry out the function.

Computing system 2000 can include a cache of high-speed memory 2006 connected directly with, in close proximity to, or integrated as part of processor 2004.

Connection 2002 can be a physical connection via a bus, or a direct connection into processor 2004, such as in a chipset architecture. Connection 2002 can also be a virtual connection, networked connection, or logical connection.

Processor 2004 can include any general purpose processor and a hardware service or software service stored in memory 2008, configured to control processor 2004 as well as a special-purpose processor where software instructions are incorporated into the actual processor design. Processor 2004 may essentially be a completely self-contained computing system, containing multiple cores or processors, a bus, memory controller, cache, etc. A multi-core processor may be symmetric or asymmetric. Processor 2004 can be physcial or virtual.

To enable user interaction, computing system 2000 includes an input device 2026, which can represent any number of input mechanisms, such as a microphone for speech, a touch-sensitive screen for gesture or graphical input, keyboard, mouse, motion input, speech, etc. Computing system 2000 can also include output device 2022, which can be one or more of a number of output mechanisms known to those of skill in the art. In some instances, multimodal systems can enable a user to provide multiple types of input/output to communicate with computing system 2000. Computing system 2000 can include communication interface 2024, which can generally govern and manage the user input and system output. There is no restriction on operating on any particular hardware arrangement, and therefore the basic features here may easily be substituted for improved hardware or firmware arrangements as they are developed.

In some embodiments, computing system 2000 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects:

The present technology includes computer-readable storage mediums for storing instructions, and systems for executing any one of the methods embodied in the instructions addressed in the aspects of the present technology presented below:

Aspect 1. A method of testing a first configuration of a customized generative response engine, the method comprising: receiving a first configuration of the customized generative response engine by an interactive test interface, wherein the first configuration comprises a system message and a first base generative response engine version, receiving a test prompt in the interactive test interface; sending the test prompt and to the customized generative response engine; receiving a response from the customized generative response engine; and presenting the response from the customized generative response engine in the interactive test interface for evaluation by a user, wherein: the system message is a directive provided to the first base generative response engine version which customizes the first base generative response engine version into the customized generative response engine to influence outputs generated by the customized generative response engine, the system message often includes operational parameters, behavioral constraints, or contextual guidance, the first base generative response engine version is a generative response engine that is provided by an artificial intelligence model publisher, wherein the first base generative response engine version is a generative pre-trained transformer, a language model, a multi-modal model, a diffusion model, a diffusion-transformer model, an embedding model, or any combination thereof, and the customized generative response engine is the first base generative response engine version that is customized by the first configuration.

Aspect 2. The ethod of aspect 1, wherein sending the test prompt and to the customized generative response engine includes one or more instructions to fabricate data on which the response depends and not to consult external sources for the data on which the response depends.

Aspect 3. The method of any of aspects 1-2, further comprising: editing, in the interactive test interface, a conversation thread comprising the test prompt and the response to provide an edited conversation thread; receiving another test prompt in the interactive test interface; sending the another test prompt to the customized generative response engine; receiving another response from the customized generative response engine the another response being based on the another prompt and the edited conversation thread, wherein the interactive test interface is stateless, such that a next response is based a current prompt and a current conversation thread when the customized generative response engine is generating the next response.

Aspect 4. The method of aspect 3, wherein: conversation thread comprises a tool call for a tool that was called by the customized generative response engine when generating the response, the editing of the conversation thread includes editing the tool in the tool call to provide an edited tool, and the another response being generated based on the edited tool.

Aspect 5. The ethod of any of aspects 1-4, further comprising: receiving an input that adjusts the first configuration into a second configuration of the customized generative response engine, thereafter the customized generative response engine with the second configuration can be tested with the test prompt or a second test prompt.

Aspect 6. The method of aspect 5, wherein the receiving the input that adjusts the first configuration into the second configuration further comprises: receiving a selection of an AI-assisted configuration creation button, wherein the AI-assisted configuration creation button is presented in multiple locations within the interactive test interface, wherein the AI-assisted configuration creation button receives a of a portion of the second configuration and provides a description as an input to an AI-assistant that generates, in response to the description, the portion of the second configuration, wherein the portion of the second configuration is at least one of the system message, code to be run by a code interpreter tool, a function to be called, or a response format.

Aspect 7. The method of any of aspects 1-6, wherein the receiving the first configuration of the customized generative response engine includes importing the first configuration from a library of previously configured customized generative response engines.

Aspect 8. The method of any of aspects 1-7, further comprising: presenting a log of activities of the customized generative response engine in generating the response, wherein the log of activities includes at least one of information about a chain of thought, files accessed, internet search results accessed and found relevant, portions of documents and webpages found relevant and used to create the response, or tools called.

Aspect 9. The method of aspect 5, wherein the input that adjusts the first configuration into the second configuration of the customized generative response engine includes input to enable the customized generative response engine to make use of a tool, wherein the tool is at least one of a file search tool, a code interpreter tool, an internet browser tool, a function tool.

Aspect 10. The method of aspect 9, wherein the input that adjusts the first configuration into the second configuration of the customized generative response engine includes input to force the customized generative response engine to use the tool for every turn, wherein a turn is characterized by a prompt and a response to the prompt.

Aspect 11. The method of any of aspects 1-10, wherein the interactive test interface is configured to test the customized generative response engine for use with (application programming interface) API endpoints.

Aspect 12. The method of aspect 11, wherein: the API endpoints include at least one of a chat-completions API endpoint, a responses API endpoint, an assistants API endpoint, a realtime API endpoint, or a computer-using-agent API endpoint, the chat-completions API endpoint comprises an interface that enables structured conversational interactions with the customized generative response engine by processing user messages, maintaining contextual awareness, and generating coherent responses based on dialogue history, the responses API endpoint comprises an interface that combines attributes of other APIs into a single interface, the assistants API endpoint comprises an interface to interact with the customized generative response engine that acts like an assistant that specializes in a type or category of tasks and has a long context history to allow it to recall past turns, the realtime API endpoint comprises an interface that facilitates real-time communication with the customized generative response engine enabling natural conversational speech interactions, and the computer-using-agent API endpoint comprises an interface to interact with the customized generative response engine that controls a computer by processing images of a graphical user interface.

Aspect 13. The method of any of aspects 1-12, further comprising: segmenting the interactive test interface into at least a first test pane and a second test pane to test at least two base generative response engine versions side-by-side; assigning the first test pane to the first configuration of the customized generative response engine, and assigning the second test pane to a second configuration of the customized generative response engine, wherein the first configuration includes the first base generative response engine version and the second configuration includes at least a second base generative response engine version, wherein the first test pane presents responses to the test prompt that are generated by the first configuration of the customized generative response engine and the second test pane presents responses to the test prompt that are generated by the second configuration of the customized generative response engine; presenting a prompt editor receives the test prompt, wherein the prompt editor is a common interface to receive the test prompt for both the first configuration of the customized generative response engine and the second configuration of the customized generative response engine.

Aspect 14. The method of aspect 13, further comprising: receiving inputs into the second test pane effective to provide the second configuration including a selection of the second base generative response engine version; and receiving an instruction to reconcile parameters, except for the first base generative response engine version and the second base generative response engine version, between the second configuration and the first configuration.

Aspect 15. The method of aspect 14, wherein reconciling the parameters between the second configuration and the first configuration comprises: communicating with a model comparison service to learn at least one capability of the second base generative response engine version as compared with one or more capabilities of the first base generative response engine version; and when possible, automatically adjusting a parameter of the second base generative response engine version to be within limits of the parameter of the second base generative response engine version.

Aspect 16. The method of aspect 15, wherein the model comparison service is a language model that is trained with knowledge of capabilities of base generative response engine versions and to compare the first base generative response engine version with the second base generative response engine version.

Aspect 17. The method of aspect 13, further comprising: after receiving the test prompt in the prompt editor, the sending of the test prompt is to the first configuration and the second configuration; and the presenting the response includes presenting the response from the first configuration in the first test pane and presenting the response from the second configuration in the second test pane.

Aspect 18. The method of aspect 17, further comprising: receiving a selection of a synchronize messages option, wherein the synchronize messages option is presented in at least one of the first test pane and second test pane, wherein the synchronize messages option is configured to cause the test prompt received in the prompt editor to be sent to the first configuration and the second configuration simultaneously, whereby a response generation speed of the first configuration and the second configuration can be compared, wherein the first base generative response engine version and the second base generative response engine version are instantiated on separate processing units.

Aspect 19. A method of interacting with real-time generative response engines having one or more user interface (UI) elements, the method comprising: presenting an interaction control interface for use with a real-time generative response engine, wherein the interaction control interface is configured to: receive a first input that is effective to start a real-time communication session, receive a second input that is effective to stop or pause the real-time communication session, and receive a third input that is effective to cause the real-time generative response engine to stop generating a particular response.

Aspect 20. The method of aspect 19, further comprising: presenting a start session option within the interaction control interface; responsive to receiving a user input selecting the start session option, presenting, in the interaction control interface at least one of a generation control UI element, a keyboard selection input, or a microphone control interface, wherein a turn is characterized by a prompt and a response to the prompt, the generation control UI element that is effective to toggle between a generating state corresponding to the real-time generative response engine generating the response and a non-generating state corresponding to the real-time generative response engine not generating a response, the keyboard selection input causes a typing interface to be presented in which a typed input can be received as the prompt, and the microphone control interface is effective to toggle between providing a sound input to the real-time generative response engine and not providing a sound input to the real-time generative response engine.

Aspect 21. The method of aspect 20, further comprising: presenting a session end UI element, wherein the session end UI element is effective to end the session, such that starting a new session starts a new chat history.

Aspect 22. The method of aspect 20, further comprising: receiving the typed input can be received as the prompt; and responsive to the receiving the typed input, setting the generation control UI element to the generating state.

Aspect 23. The method of any of aspects 20-22, further comprising: receiving the typed input can be received as the prompt; and responsive to the receiving the typed input, maintaining a current state of the generation control UI element, and, when the current state is the not generating state, waiting until the generation control UI element is toggled to the generating state to generate the response to the typed input.

Aspect 24. The method of any of aspects 19-23, further comprising: presenting a start session option within the interaction control interface; responsive to receiving a user input selecting the start session option, presenting, in the interaction control interface a generation control UI element that is effective to toggle between a generating state corresponding to the real-time generative response engine generating a response and a non-generating state corresponding to the real-time generative response engine not generating the response, wherein toggling the generation control UI element to the generating state causes a first command to be sent to the real-time generative response engine to stream the response based on a chat history of the session, and toggling the generation control UI element to the not generating state causes a second command to be sent to the real-time generative response engine to surrender a turn and discontinue streaming the response while maintaining the session.

Aspect 25. The method of any of aspects 19-24, further comprising: presenting, in the interaction control interface, an automatic turn detection UI element; and responsive to receiving a user input selecting the automatic turn detection UI element, enabling automatic turn detection, wherein when the automatic turn detection, is enabled, the interaction control interface automatically determines when to generate a response for a turn and when to surrender the turn and wait for an indication to generate another response, wherein the turn is characterized by a prompt and the response to the prompt.

Aspect 26. The method of aspect 25, further comprising: presenting a start session option within the interaction control interface; responsive to receiving a user input selecting the start session option, causing a computing device to initiate recording of a sound input and to send information of the sound input to the real-time generative response engine for processing; also responsive to the receiving the user input selecting the start session option, presenting a sound input activity monitor, wherein the sound input activity monitor presents an animation that is correlated to a decibel level of the sound input recorded by the computing device, wherein the sound input activity monitor replaces the start session option in the interaction control interface.

Aspect 27. The method of aspect 26, further comprising: determining, by the real-time generative response engine, that the sound input includes speech; and sending, by the real-time generative response engine, a signal to the interaction control interface indicating that the speech is currently being detected; modifying the animation to indicate that the speech is detected in the sound input, wherein the modifying the input includes changing a color of the animation that is correlated to the decibel level of the sound input.

Aspect 28. The method of any of aspects 19-27, further comprising: presenting a start session option within the interaction control interface; responsive to receiving a user input selecting the start session option, starting a session and presenting the generation control UI element that is effective to discontinue an active response generation by the real-time generative response engine, while maintaining the session; while the real-time generative response engine is streaming a response, receiving a selection of the generation control UI element; after receiving the selection of the generation control UI element, sending a command to the real-time generative response engine to surrender a turn and discontinue streaming the response.

Aspect 29. The method of aspect 26, further comprising: presenting a keyboard selection input that is configured to cause the interaction control interface to accept typed inputs; receiving a selection of the keyboard selection input; and after the selection of the keyboard selection input, receiving the typed inputs from a typing interface and sending the typed inputs to the real-time generative response engine as a prompt.

Aspect 30. The method of aspect 29, further comprising: after the selection of the keyboard selection input, continuing to provide the information of the sound input to the real-time generative response engine as the prompt while also providing the typed inputs as another prompt.

Aspect 31. The method of aspect 25, further comprising: receiving another selection of the automatic turn detection UI element that disables the automatic turn detection; sending an instruction to the real-time generative response engine to turn off automatic turn detection; and transitioning the interaction control interface to a manual turn mode.

Aspect 32. The method of aspect 25, further comprising: operating the interaction control interface to a manual turn mode.

Aspect 33. The method of aspect 32, further comprising: presenting a start session option within the interaction control interface; responsive to a selection of the start session option, presenting a talk UI element; responsive to a selection of the talk UI element recording sound input, converting the sound input to and sending information of the sound input to the real-time generative response engine for processing; and displaying sound input activity monitor representing a sound amplitude or a decibel level of the sound inputs recorded.

Aspect 34. The method of aspect 33, wherein: the talk UI element replaces the start session option, upon the selection of the start session option, and the sound input activity monitor replaces the talk UI element, upon a selection of the talk UI element.

Aspect 35. The method of aspect 33, wherein: the information of the sound input is text generated by processing the sound input using a speech-to-text converter, and the information of the sound input lacks identifying information a speaker apart from words spoken by the speaker.

Aspect 36. The method of aspect 33, further comprising: responsive to a selection in a region in the sound input activity monitor, discontinuing the sending of the information of the sound input to the real-time generative response engine; and responsive to the selection in the region in the sound input activity monitor, signaling to the real-time generative response engine to generate the response.

Aspect 37. The method of aspect 32, further comprising: presenting a start session option within the interaction control interface; responsive to receiving a selection the start session option, presenting a generation control UI element that is effective to toggle between a generating state and non-generating state, wherein: when in the generating state, the interaction control interface causes the real-time generative response engine to stream the response, when in the non-generating state, the interaction control interface causes the real-time generative response engine to not stream the response and to surrender a turn, and toggling the generation control UI element maintains the session.

Aspect 38. The method of aspect 37, further comprising: upon completion of the response by the real-time generative response engine, setting the generation control UI element to the non-generating state; and while streaming the response, toggling the generation control UI element to the non-generating state causes the real-time generative response engine to discontinue streaming the response without completing the response and surrendering the turn.

Aspect 39. The method of aspect 37, further comprising: toggling the generation control UI element to the non-generating state causes the real-time generative response engine to generate the response based on all of a chat history within a context window.

Aspect 40. A method of interacting with real-time generative response engines having automatic turn detection capabilities, the method comprising: presenting an interaction control interface for use with a real-time generative response engine when automatic turn detection is enabled, wherein the interaction control interface is configured to receive inputs that are effective to start a real-time communication session, to stop or pause the real-time communication session, cause the real-time generative response engine to stop generating a particular response.

Aspect 41. The method of aspect 40, further comprising: presenting a start session option within the interaction control interface; responsive to receiving a user input selecting the start session option, causing a computing device to initiate recording of a sound input and to send the sound input to the real-time generative response engine for processing; also responsive to the receiving the user input selecting the start session option, presenting a sound input activity monitor, wherein the sound input activity monitor presents an animation that is correlated to a decibel level of the sound input recorded by the computing device, wherein the sound input activity monitor replaces the start session option in the interaction control interface.

Aspect 42. The method of aspect 41, further comprising: determining, by the real-time generative response engine, that the sound input includes speech; and sending, by the real-time generative response engine, a flag to the interaction control interface indicating that the speech is currently being detected; modifying the animation to indicate that the speech is detected in the sound input, wherein the modifying the input includes changing a color of the animation that is correlated to the decibel level of the sound input.

Aspect 43. The method of any of aspects 40-42, further comprising: presenting a start session option within the interaction control interface; responsive to receiving a user input selecting the start session option, starting a session and presenting a generation control UI element that is effective to discontinue an active response generation by the real-time generative response engine, while maintaining the session; while the real-time generative response engine is streaming a response, receiving a user input interacting with the generation control UI element; after receiving the user input interacting with the generation control UI element, sending a command to the real-time generative response engine to surrender a turn and discontinue streaming the response.

Aspect 44. The further of aspect 43, further comprising: listening, by the real-time generative response engine and after receiving the user input interacting with the generation control UI element, for further prompt.

Aspect 45. The method of any of aspects 41-44, further comprising: presenting a microphone control interface that is configured to discontinue providing the sound input to the real-time generative response engine.

Aspect 46. The method of any of aspects 41-45, further comprising: presenting a keyboard selection input that is configured to cause the interaction control interface to accept typed inputs; receiving a selection of the keyboard selection input; and after the selection of the keyboard selection input, receiving typed inputs from a typing interface and sending the inputs to the real-time generative response engine as a prompt.

Aspect 47. The method of aspect 46, further comprising: after the selection of the keyboard selection input, discontinuing to provide the sound input to the real-time generative response engine.

Aspect 48. The method of any of aspects 41-47, further comprising: presenting an automatic turn detection UI element, wherein the automatic turn detection UI element is configured to turn on and turn off the automatic turn detection; receiving a selection of the automatic turn detection UI element; sending an instruction to the real-time generative response engine to turn off automatic turn detection; and transitioning the interaction control interface into a prompt editing interface.

Aspect 49. A non-transitory computer readable medium comprising one or more sequences of instructions, which, when executed by a processor, cause a computing system associated with a content management system to perform operations of the method of any of aspects 1-48.

Aspect 50. A computing system comprising: one or more processors; and a memory having programming instructions stored thereon, which, when executed by the one or more processors, causes the computing system to perform operations of the method of any of aspects 1-48.

What is claimed is:

1. A method of testing a first configuration of a customized generative response engine, the method comprising:
receiving a first configuration of the customized generative response engine by an interactive test interface, wherein the first configuration includes at least a system message, and a base generative response engine version,
causing the customized generative response engine to be configured according to the first configuration to provide a first customized generative response engine;
receiving a test prompt in the interactive test interface;
sending the test prompt to the first customized generative response engine;
receiving a first response from the first customized generative response engine; and
presenting the first response in the interactive test interface for evaluation by a user.

2. The method of claim 1, wherein:
the system message is a directive provided to the base generative response engine version that contributes to customizing the base generative response engine version to provide the customized generative response engine,
the system message influences an output generated by the customized generative response engine including at least one of a tone of the output, a level of detail of the output, formatting of the output, a length of the output, a contextual focus of the output, operational parameters for generating the output, behavioral constraints of the output, or contextual guidance for generating the output,
the base generative response engine version is a generative inference engine that is provided by an artificial intelligence model publisher,
the base generative response engine version includes at least one of a generative pre-trained transformer, a language model, a multi-modal model, a diffusion model, a diffusion-transformer model, or an embedding model, and
the customized generative response engine is the base generative response engine version that is customized by the first configuration.

3. The method of claim 1, further comprising:
receiving an input that modifies the first configuration to provide a second configuration of the customized generative response engine; and
causing the customized generative response engine to be configured according to the second configuration to provide a second customized generative response engine.

4. The method of claim 3, further comprising:
sending the test prompt or another test prompt to the second customized generative response engine to cause a second response to be generated;
receiving a second response from the customized generative response engine; and
presenting the second response in the interactive test interface for evaluation by the user.

5. The method of claim 3, wherein the receiving of the input that modifies the first configuration into the second configuration further comprises:
receiving a selection of an AI-assisted configuration creation button, wherein the AI-assisted configuration creation button is presented in respective locations within the interactive test interface, the respective locations being associated with contributions to the first configuration.

6. The method of claim 5, wherein the AI-assisted configuration creation button is configured to:
receive a description of a desired functionality of a contribution to the first configuration that is associated with a location of the AI-assisted configuration creation button,
send the description of a desired functionality to an AI-assistant thereby causing the AI-assistant to generate recommended text for the contributions to the first configuration,
receive the recommended text and present the recommended text for evaluation by a user, and
the contribution to the first configuration that is associated with the location of the AI-assisted configuration creation button includes at least one of the system message, a function call, a tool call, a response format schema, or a JSON schema.

7. The method of claim 3, wherein the input that modifies the first configuration to provide the second configuration of the customized generative response engine includes a tool selection that enables the customized generative response engine to use a tool.

8. The method of claim 7, wherein the tool is at least one of a file search tool, a code interpreter tool, an internet browser tool, or a function tool.

9. The method of claim 7, wherein the input that modifies the first configuration to provide the second configuration of the customized generative response engine includes another selection that forces the second customized generative response engine to use the tool for respective turns.

10. The method of claim 1, wherein the receiving the first configuration of the customized generative response engine includes importing the first configuration from a library of previously configured customized generative response engines.

11. The method of claim 1, further comprising:
presenting a log of activities of the customized generative response engine in generating the response, wherein activities can include at least one of information about a chain of thought, information about files accessed, internet search results accessed, information about internet search results found relevant, portions of documents and webpages found relevant and used to create the response, or tools called.

12. The method of claim 1, wherein the interactive test interface is configured to test the customized generative response engine for use with a plurality of application programming interface (API) endpoints, wherein the plurality of API endpoints includes at least one of a chat completions API endpoint, a responses API endpoint, an assistants API endpoint, a realtime API endpoint, or computer using agent API endpoint.

13. A computing apparatus comprising:
one or more processors; and
a memory storing instructions that, when executed by the one or more processors, configure the computing apparatus to:
receive a first configuration of a customized generative response engine by an interactive test interface, wherein the first configuration includes at least a system message, and a base generative response engine version,
cause the customized generative response engine to be configured according to the first configuration to provide a first customized generative response engine;
receiving a test prompt in the interactive test interface;
send the test prompt to the first customized generative response engine;
receiving a first response from the first customized generative response engine; and
present the first response in the interactive test interface for evaluation by a user.

14. The computing apparatus of claim 13, wherein:
the system message is a directive provided to the base generative response engine version that contributes to customizing the base generative response engine version to provide the customized generative response engine,
the system message influences an output generated by the customized generative response engine including at least one of a tone of the output, a level of detail of the output, formatting of the output, a length of the output, a contextual focus of the output, operational parameters for generating the output, behavioral constraints of the output, or contextual guidance for generating the output,
the base generative response engine version is a generative inference engine that is provided by an artificial intelligence model publisher,
the base generative response engine version includes at least one of a generative pre-trained transformer, a language model, a multi-modal model, a diffusion model, a diffusion-transformer model, or an embedding model, and
the customized generative response engine is the base generative response engine version that is customized by the first configuration.

15. The computing apparatus of claim 13, wherein the instructions further configure the computing apparatus to:
receive an input that modifies the first configuration to provide a second configuration of the customized generative response engine, and
cause the customized generative response engine to be configured according to the second configuration to provide a second customized generative response engine.

16. The computing apparatus of claim 15, wherein the instructions further configure the computing apparatus to:
send the test prompt or another test prompt to the second customized generative response engine to cause a second response to be generated,
receive a second response from the customized generative response engine, and
present the second response in the interactive test interface for evaluation by the user.

17. The computing apparatus of claim 15, wherein receiving the input that modifies the first configuration into the second configuration further includes that he instructions further configure the computing apparatus to:
receive a selection of an AI-assisted configuration creation button, wherein the AI-assisted configuration creation button is presented in respective locations within the interactive test interface, the respective locations being associated with contributions to the first configuration.

18. The computing apparatus of claim 17, wherein the AI-assisted configuration creation button is configured to:
receive a description of a desired functionality of a contribution to the first configuration that is associated with a location of the AI-assisted configuration creation button,
send the description of a desired functionality to an AI-assistant thereby causing the AI-assistant to generate recommended text for the contributions to the first configuration,
receive the recommended text and present the recommended text for evaluation by a user, and
the contribution to the first configuration that is associated with the location of the AI-assisted configuration creation button includes at least one of the system message, a function call, a tool call, a response format schema definition, or a JSON schema.

19. The computing apparatus of claim 15, wherein:
the input that modifies the first configuration to provide the second configuration of the customized generative response engine includes a tool selection that enables the customized generative response engine to use a tool, and
the tool is at least one of a file search tool, a code interpreter tool, an internet browser tool, or a function tool.

20. A non-transitory computer-readable storage medium, the computer-readable storage medium including instructions that when executed by a computer, cause the computer to:
receive a first configuration of a customized generative response engine by an interactive test interface, wherein the first configuration includes at least a system message, and a base generative response engine version,
cause the customized generative response engine to be configured according to the first configuration to provide a first customized generative response engine;
receive a test prompt in the interactive test interface;
send the test prompt to the first customized generative response engine;
receive a first response from the first customized generative response engine; and
present the first response in the interactive test interface for evaluation by a user.
